(19) United States
(12) Patent Application Publication
(10) Pub. No.: US 2025/0294186 A1
(43) Pub. Date: Sep. 18, 2025

(54) POSITIONAL ENCODING FOR POINT CLOUD COMPRESSION

(71) Applicant: QUALCOMM Incorporated, San Diego, CA (US)

(72) Inventors: Anique Akhtar, San Diego, CA (US); Geert Van der Auwera, San Diego, CA (US); Reetu Hooda, San Diego, CA (US); Marta Karczewicz, San Diego, CA (US)

(21) Appl. No.: 18/606,470

(22) Filed: Mar. 15, 2024

(51) Int. Cl. H04N 19/597; G06T 7/60; G06V 10/28; G06V 10/44; G06V 10/80; H04N 19/30; H04N 19/70; H04N 19/96

(52) U.S. Cl. CPC H04N 19/597; G06T 7/60; G06V 10/28; G06V 10/44; G06V 10/806; H04N 19/30; H04N 19/70; H04N 19/96

(57) ABSTRACT

A point cloud encoder is configured to receive a frame of point cloud data and encode coordinates of a geometry of the frame of point cloud data using a deep learning network. The deep learning network includes one or more layers configured to generate first features for the coordinates of the geometry, and at least one positional encoding layer configured to generate second features for the coordinates of the geometry and combine the first features with the second features to generate higher-dimensional features. The point cloud encoder may output an output tensor comprising encoded coordinates and the higher-dimensional features.

### TECHNICAL FIELD

This disclosure relates to point cloud compression, including point cloud encoding and decoding.

### BACKGROUND

A point cloud is a collection of points in a 3-dimensional space. The points may correspond to points on objects within the 3-dimensional space. Thus, a point cloud may be used to represent the physical content of the 3-dimensional space. Point clouds may have utility in a wide variety of situations. For example, point clouds may be used in the context of autonomous vehicles for representing the positions of objects on a roadway. In another example, point clouds may be used in the context of representing the physical content of an environment for purposes of positioning virtual objects in an augmented reality (AR) or mixed reality (MR) application. Point cloud compression is a process for encoding and decoding point clouds. Encoding point clouds may reduce the amount of data required for storage and transmission of point clouds.

### SUMMARY

In general, this disclosure describes techniques for point cloud compression, including techniques for using artificial intelligence (AI) and neural networks techniques in performing the compression. In particular, this disclosure describes techniques and devices that use one or more positional encoding layers in an encoder and decoder network for AI-based point cloud compression. The positional encoding layers described herein may be used for both geometry compression (e.g., the coordinates of the point cloud), as well as for attribute compression (e.g., colors, normal vectors, reflectance, or other attributes of the points).

In the context of geometry encoding, an encoder network may include several stages of downsampling (also called downscaling) where the number of points are progressively reduced. The coordinates of these downsampled points, as well as associated feature attributes, are output by the AI-based encoder. This disclosure describes techniques where one or more positional encoding layers are added into the encoder network. The positional encoding layers create additional, higher-dimensional features that are generated from the currently processed coordinates. The features are higher-dimensional relative to other feature tensors generated by the encoder or decoder network. These additional, higher-dimensional feature attributes are combined (e.g., concatenated) to the feature tensors generated by the other layers of the encoder network. By increasing the dimensionality of the feature tensors generated by the encoder network with the positional encoding layers, the techniques of this disclosure may improve the efficiency of the compression.

In one example, this disclosure describes an apparatus configured to encode a point cloud, the apparatus comprising one or more memories configured to store point cloud data, and processing circuitry in communication with the one or more memories, the processing circuitry configured to receive a frame of point cloud data, encode coordinates of a geometry of the frame of point cloud data using a deep learning network, wherein the deep learning network includes one or more layers configured to generate first features for the coordinates of the geometry, and wherein the deep learning network further includes at least one positional encoding layer configured to generate second features for the coordinates of the geometry and combine the first features with the second features to generate higher-dimensional features, and output an output tensor comprising encoded coordinates and the higher-dimensional features.

In another example, this disclosure describes a method of encoding a point cloud, the method comprising receiving a frame of point cloud data, encoding coordinates of a geometry of the frame of point cloud data using a deep learning network, wherein the deep learning network includes one or more layers configured to generate first features for the coordinates of the geometry, and wherein the deep learning network further includes at least one positional encoding layer configured to generate second features for the coordinates of the geometry and combine the first features with the second features to generate higher-dimensional features, and outputting an output tensor comprising encoded coordinates and the higher-dimensional features.

In another example, this disclosure describes an apparatus configured to decode encoded point cloud data, the apparatus comprising one or more memories configured to store the encoded point cloud data and processing circuitry in communication with the one or more memories, the processing circuitry configured to receive a frame of the encoded point cloud data, wherein the encoded point cloud data includes an input tensor comprising encoded coordinates and corresponding features, decode coordinates of a geometry of the frame of the encoded point cloud data using a deep learning network and the input tensor to generate decoded coordinates, wherein the deep learning network includes one or more layers configured to generate first features for the coordinates of the geometry, wherein the deep learning network further includes at least one positional encoding layer configured to generate second features for the coordinates of the geometry and combine the first features with the second features to generate higher-dimensional features, and wherein the deep learning network further includes one or more classifier layers configured to classify the higher-dimensional features to generate the decoded coordinates, and output the decoded coordinates in a decoded point cloud.

In another example, this disclosure describes a method of decoding a point cloud, the method comprising receiving a frame of encoded point cloud data, wherein the encoded point cloud data includes an input tensor comprising encoded coordinates and corresponding features, decoding coordinates of a geometry of the frame of the encoded point cloud data using a deep learning network and the input tensor to generate decoded coordinates, wherein the deep learning network includes one or more layers configured to generate first features for the coordinates of the geometry, wherein the deep learning network further includes at least one positional encoding layer configured to generate second features for the coordinates of the geometry and combine the first features with the second features to generate higher-dimensional features, and wherein the deep learning network further includes one or more classifier layers configured to classify the higher-dimensional features to generate the decoded coordinates, and outputting the decoded coordinates in a decoded point cloud.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 is a block diagram illustrating an example point cloud encoder that may perform the techniques of this disclosure.

FIG. 3 is a block diagram illustrating an example point cloud decoder that may perform the techniques of this disclosure.

FIG. 4 is a block diagram illustrating an example system model for AI-based point cloud compression that may perform the techniques of this disclosure.

FIG. 5 is a block diagram illustrating an example encoder network of FIG. 4 in accordance with the techniques of this disclosure.

FIG. 6 is a block diagram illustrating an example decoder network of FIG. 4 in accordance with the techniques of this disclosure.

FIG. 7 is a block diagram illustrating an example encoder network with positional encoding in accordance with the techniques of this disclosure.

FIG. 8 is a block diagram illustrating an example decoder network with positional encoding in accordance with the techniques of this disclosure.

FIG. 9 is a block diagram illustrating an example system model for AI-based point cloud compression with positional encoding that may perform the techniques of this disclosure.

FIG. 10 is a block diagram illustrating an example positional encoding layer in accordance with the techniques of this disclosure.

FIG. 11A is a graph showing a test of compression efficiency of a features bitstream encoded in accordance with the techniques of this disclosure.

FIG. 11B is a graph showing a test of compression efficiency of an overall bitstream encoded in accordance with the techniques of this disclosure.

FIG. 12 is a flowchart showing an example encoding technique of the disclosure.

FIG. 13 is a flowchart showing an example decoding technique of the disclosure.

FIG. 14 is a conceptual diagram illustrating an example range-finding system that may be used with one or more techniques of this disclosure.

FIG. 15 is a conceptual diagram illustrating an example vehicle-based scenario in which one or more techniques of this disclosure may be used.

FIG. 16 is a conceptual diagram illustrating an example extended reality system in which one or more techniques of this disclosure may be used.

FIG. 17 is a conceptual diagram illustrating an example mobile device system in which one or more techniques of this disclosure may be used.

### DETAILED DESCRIPTION

A point cloud (PC) is a 3D data representation that is useful for tasks like virtual reality (VR) and mixed reality (MR), autonomous driving, cultural heritage, etc. PCs are a set of points in 3D space, represented by their 3D coordinates (x, y, z) referred to as the geometry. Each point may also be associated with multiple attributes such as color, normal vectors, and reflectance. Depending on the target application and the PC acquisition methods, the PC can be categorized into point cloud scenes and point cloud objects.

A static PC is a single object, whereas a dynamic PC is a time-varying PC where each instance of a dynamic PC is a static PC. These PCs can have a massive number of points, especially in high precision or large-scale captures (e.g., millions of points per frame with up to 60 frames per second (FPS)). Therefore, efficient point cloud compression (PCC) may be particularly important to enable practical usage in VR, MR, and automotive applications.

The Moving Picture Experts Group (MPEG) has approved two PCC standards. One standard is called Geometry-based Point Cloud Compression (G-PCC), and the other standards is called Video-based Point Cloud Compression (V-PCC). G-PCC includes octree-geometry coding as a generic geometry coding tool and a predictive geometry coding (tree-based) tool which is targeted toward LiDAR-based point clouds. Some examples of G-PCC may include triangle meshes or triangle soup (trisoup) based methods to approximate the surface of the 3D model. V-PCC encodes dynamic point clouds by projecting 3D points onto a 2D plane and then uses video codecs, e.g., High-Efficiency Video Coding (HEVC), to encode each frame over time. MPEG is also working on an AI-based Point Cloud Compression (AI-PCC also referred to as AI-3DGC or AI-GC) standard.

In some examples, AI-based point cloud compression techniques may include the use of end-to-end deep learning solutions. Since point clouds have both geometry as well as attributes, there have been solutions proposed for point cloud geometry compression, point cloud attribute compression, as well as joint point cloud geometry and attribute compression. In one general example, point cloud compression for dense dynamic point clouds may be performed using a deep learning network including an encoding unit and a decoding unit. The encoding unit may extract features from the point cloud geometry into a downscaled point cloud geometry (e.g., three-times downscaled or 8× downscaling) with corresponding feature embedding. The downscaled geometry and the corresponding features may be transmitted to the decoding unit. The decoding unit may then hierarchically reconstruct the original point cloud geometry from the downscaled representation using progressive rescaling.

Positional encoding is a deep learning techniques that has been used in natural language processing (NLP) and large language models (LLM). Positional encoding is a technique used to provide positional information to the model, such as the order of the words in a sentence, when processing text sequences. Positional encoding has also been used in vision tasks where the pixel locations of an image are provided to the neural network to understand the spatial relationships between pixels. Positional encoding typically involves applying mathematical representations to the location to get a higher dimensional feature representation. These features may be incorporated as additional channels or features in the input data, allowing the model to recognize the position and orientation of objects or patterns in the image.

This disclosure describes techniques where one or more positional encoding layers are added into the encoder network and decoder network for AI-based point cloud compression. The positional encoding layers create additional, higher-dimensional features that are generated from the currently processed coordinates. These additional, higher-dimensional feature attributes are combined (e.g., concatenated) to the feature tensors generated by the other layers of the encoder network and decoder network. By increasing the dimensionality of the feature tensors generated by the networks with the positional encoding layers, the techniques of this disclosure may improve the efficiency of the point cloud compression.

In one example, a point cloud encoder is configured to receive a frame of point cloud data and encode coordinates of a geometry of the frame of point cloud data using a deep learning network. The deep learning network includes one or more layers configured to generate first features for the coordinates of the geometry, and at least one positional encoding layer configured to generate second features for the coordinates of the geometry and combine the first features with the second features to generate higher-dimensional features. The point cloud encoder may output an output tensor comprising encoded coordinates and the higher-dimensional features.

In a reciprocal example, a point cloud decoder may receive a frame of encoded point cloud data, where the encoded point cloud data includes an input tensor comprising encoded coordinates and corresponding features. The point cloud decoder may decode coordinates of a geometry of the frame of the encoded point cloud data using a deep learning network and the input tensor to generate decoded coordinates. The deep learning network includes one or more layers configured to generate first features for the coordinates of the geometry, at least one positional encoding layer configured to generate second features for the coordinates of the geometry and combine the first features with the second features to generate higher-dimensional features, one or more classifier layers configured to classify the higher-dimensional features to generate the decoded coordinates. The point cloud decoder may output the decoded coordinates in a decoded point cloud.

In the examples below, the terms “positional encoding” and “positional embedding” may be used interchangeably.

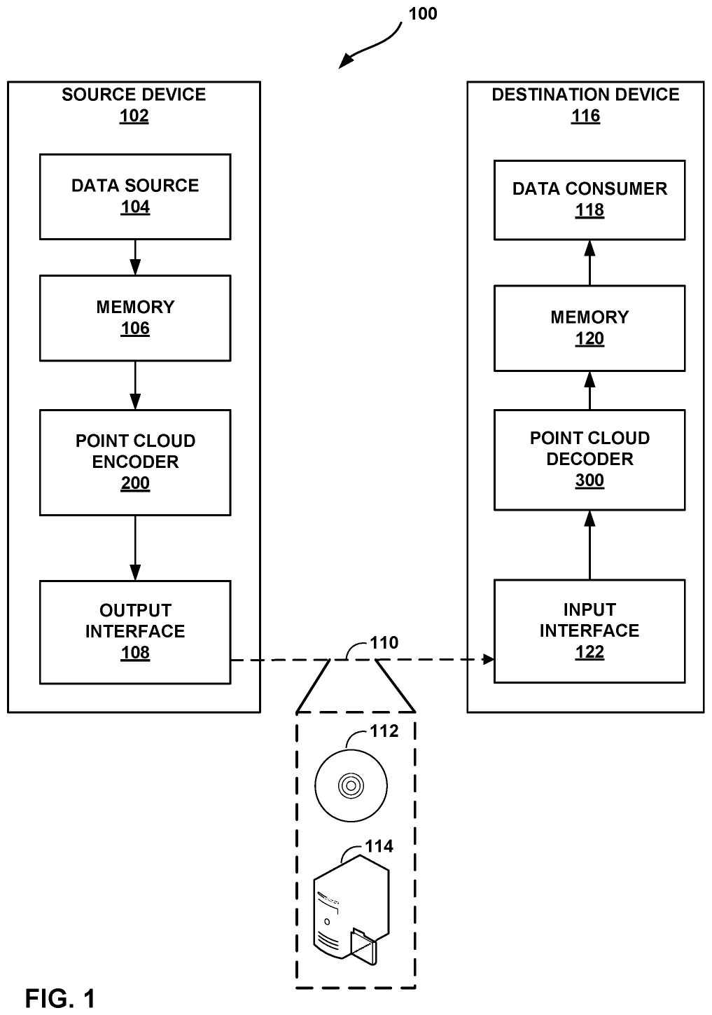

FIG. 1 is a block diagram illustrating an example encoding and decoding system 100 that may perform the techniques of this disclosure. The techniques of this disclosure are generally directed to AI-based coding (encoding and/or decoding) of point cloud data, i.e., to support point cloud compression. In general, point cloud data includes any data for processing a point cloud. The coding may be effective in compressing and/or decompressing point cloud data.

As shown in FIG. 1, system 100 includes a source device 102 and a destination device 116. Source device 102 provides encoded point cloud data to be decoded by a destination device 116. Particularly, in the example of FIG. 1, source device 102 provides the point cloud data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR devices, satellites, or the like. In some cases, source device 102 and destination device 116 may be equipped for wireless communication.

In the example of FIG. 1, source device 102 includes a data source 104, a memory 106, a point cloud encoder 200, and an output interface 108. Destination device 116 includes an input interface 122, a point cloud decoder 300, a memory 120, and a data consumer 118. In accordance with this disclosure, point cloud encoder 200 of source device 102 and point cloud decoder 300 of destination device 116 may be configured to apply the techniques of this disclosure related to AI-based point cloud encoding and encoding using positional encoding techniques. Thus, source device 102 represents an example of an encoding device, while destination device 116 represents an example of a decoding device. In other examples, source device 102 and destination device 116 may include other components or arrangements. For example, source device 102 may receive data (e.g., point cloud data) from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to AI-based point cloud encoding and encoding. Source device 102 and destination device 116 are merely examples of such devices in which source device 102 generates coded data for transmission to destination device 116. This disclosure refers to a “coding” device as a device that performs coding (encoding and/or decoding) of data. Thus, point cloud encoder 200 and point cloud decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (i.e., raw, unencoded point cloud data) and may provide a sequential series of “frames”) of the data to point cloud encoder 200, which encodes data for the frames. Data source 104 of source device 102 may include a point cloud capture device, such as any of a variety of cameras or sensors, e.g., a 3D scanner or a light detection and ranging (LIDAR) device, one or more video cameras, an archive containing previously captured data, and/or a data feed interface to receive data from a data content provider. Alternatively or additionally, point cloud data may be computer-generated from scanner, camera, sensor or other data. For example, data source 104 may generate computer graphics-based data as the source data, or produce a combination of live data, archived data, and computer-generated data. In each case, point cloud encoder 200 encodes the captured, pre-captured, or computer-generated data. Point cloud encoder 200 may rearrange the frames from the received order (sometimes referred to as “display order”) into a coding order for coding. Point cloud encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from point cloud decoder 300. Additionally or alternatively, memory 106 and memory 120 may store software instructions executable by, e.g., point cloud encoder 200 and point cloud decoder 300, respectively. Although memory 106 and memory 120 are shown separately from point cloud encoder 200 and point cloud decoder 300 in this example, it should be understood that point cloud encoder 200 and point cloud decoder 300 may also include internal memories for functionally similar or equivalent purposes. Furthermore, memory 106 and memory 120 may store encoded data, e.g., output from point cloud encoder 200 and input to point cloud decoder 300. In some examples, portions of memory 106 and memory 120 may be allocated as one or more buffers, e.g., to store raw, decoded, and/or encoded data. For instance, memory 106 and memory 120 may store data representing a point cloud.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to point cloud encoder 200 and/or output interface 108, and destination device 116 may include an SoC device to perform the functionality attributed to point cloud decoder 300 and/or input interface 122.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by point cloud encoder 200, which is also used by point cloud decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on a point cloud.

Point cloud encoder 200 and point cloud decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware, or any combinations thereof. When the techniques are implemented partially in software, a device may store instructions for the software in a suitable, non-transitory computer-readable medium and execute the instructions in hardware using one or more processors to perform the techniques of this disclosure. Each of point cloud encoder 200 and point cloud decoder 300 may be included in one or more encoders or decoders, either of which may be integrated as part of a combined encoder/decoder (CODEC) in a respective device. A device including point cloud encoder 200 and/or point cloud decoder 300 may comprise one or more integrated circuits, microprocessors, and/or other types of devices.

This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, point cloud encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

ISO/IEC MPEG (JTC 1/SC 29/WG 11) has studied and continues to study the potential need for standardization of point cloud coding technology with a compression capability that significantly exceeds that of the current approaches. The group is working together on this exploration activity in a collaborative effort known as the 3-Dimensional Graphics Team (3DG) to evaluate compression technology designs proposed by their experts in this area.

The Moving Picture Experts Group (MPEG) has approved two PCC standards. One standard is called Geometry-based Point Cloud Compression (G-PCC), and the other standards is called Video-based Point Cloud Compression (V-PCC). G-PCC includes octree-geometry coding as a generic geometry coding tool and a predictive geometry coding (tree-based) tool which is targeted toward LiDAR-based point clouds. Some examples of G-PCC may include triangle meshes or triangle soup (trisoup) based methods to approximate the surface of the 3D model. V-PCC encodes dynamic point clouds by projecting 3D points onto a 2D plane and then uses video codecs, e.g., High-Efficiency Video Coding (HEVC), to encode each frame over time. MPEG is also working on an AI-based Point Cloud Compression (AI-PCC also referred to as AI-3DGC or AI-GC) standard.

In some examples, AI-based point cloud compression techniques may include the use of end-to-end deep learning solutions. Since point clouds have both geometry as well as attributes, there have been solutions proposed for point cloud geometry compression, point cloud attribute compression, as well as joint point cloud geometry and attribute compression. In one general example, point cloud compression for dense dynamic point clouds may be performed using a deep learning network including an encoding unit and a decoding unit. The encoding unit may extract features from the point cloud geometry into a downscaled point cloud geometry (e.g., three-times downscaled) with corresponding feature embedding. The downscaled geometry and the corresponding features may be transmitted to the decoding unit. The decoding unit may then hierarchically reconstruct the original point cloud geometry from the downscaled representation using progressive rescaling.

Positional encoding is a deep learning techniques that has been used in natural language processing (NLP) and large language models (LLM). Positional encoding is a technique used to provide positional information to the model, such as the order of the words in a sentence, when processing text sequences. Positional encoding has also been used in vision tasks where the pixel locations of an image are provided to the neural network to understand the spatial relationships between pixels. Positional encoding typically involves applying mathematical representations to the location to get a higher dimensional feature representation. These features may be incorporated as additional channels or features in the input data, allowing the model to recognize the position and orientation of objects or patterns in the image.

This disclosure describes techniques where one or more positional encoding layers are added into the encoder network and decoder network for AI-based point cloud compression. The positional encoding layers create additional, higher-dimensional feature that are generated from the currently processed coordinates. The features are higher-dimensional relative to other feature tensors generated by the encoder or decoder network. These additional, higher-dimensional feature attributes are combined (e.g., concatenated) to the feature tensors generated by the other layers of the encoder network and decoder network. By increasing the dimensionality of the feature tensors generated by the networks with the positional encoding layers, the techniques of this disclosure may improve the efficiency of the point cloud compression.

In one example, as will be explained in more detail below point cloud encoder 200 may be configured to receive a frame of point cloud data and encode coordinates of a geometry of the frame of point cloud data using a deep learning network. The deep learning network includes one or more layers configured to generate first features for the coordinates of the geometry, and at least one positional encoding layer configured to generate second features for the coordinates of the geometry and combine the first features with the second features to generate higher-dimensional features. Point cloud encoder 200 may output an output tensor comprising encoded coordinates and the higher-dimensional features.

In a reciprocal example, point cloud decoder 300 may receive a frame of encoded point cloud data, where the encoded point cloud data includes an input tensor comprising encoded coordinates and corresponding features. The point cloud decoder may decode coordinates of a geometry of the frame of the encoded point cloud data using a deep learning network and the input tensor to generate decoded coordinates. The deep learning network includes one or more layers configured to generate first features for the coordinates of the geometry, at least one positional encoding layer configured to generate second features for the coordinates of the geometry and combine the first features with the second features to generate higher-dimensional features, one or more classifer layers configured to classify the higher-dimensional features to generate the decoded coordinates. Point cloud decoder 300 may output the decoded coordinates in a decoded point cloud.

In the examples below, the terms “positional encoding” and “positional embedding” may be used interchangeably.

A point cloud contains a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

The 3D space occupied by a point cloud data may be enclosed by a virtual bounding box. The position of the points in the bounding box may be represented by a certain precision; therefore, the positions of one or more points may be quantized based on the precision. At the smallest level, the bounding box is split into voxels which are the smallest unit of space represented by a unit cube. A voxel in the bounding box may be associated with zero, one, or more than one point. The bounding box may be split into multiple cube/cuboid regions, which may be called tiles. Each tile may be coded into one or more slices. The partitioning of the bounding box into slices and tiles may be based on number of points in each partition, or based on other considerations (e.g., a particular region may be coded as tiles). The slice regions may be further partitioned using splitting decisions similar to those in video codecs.

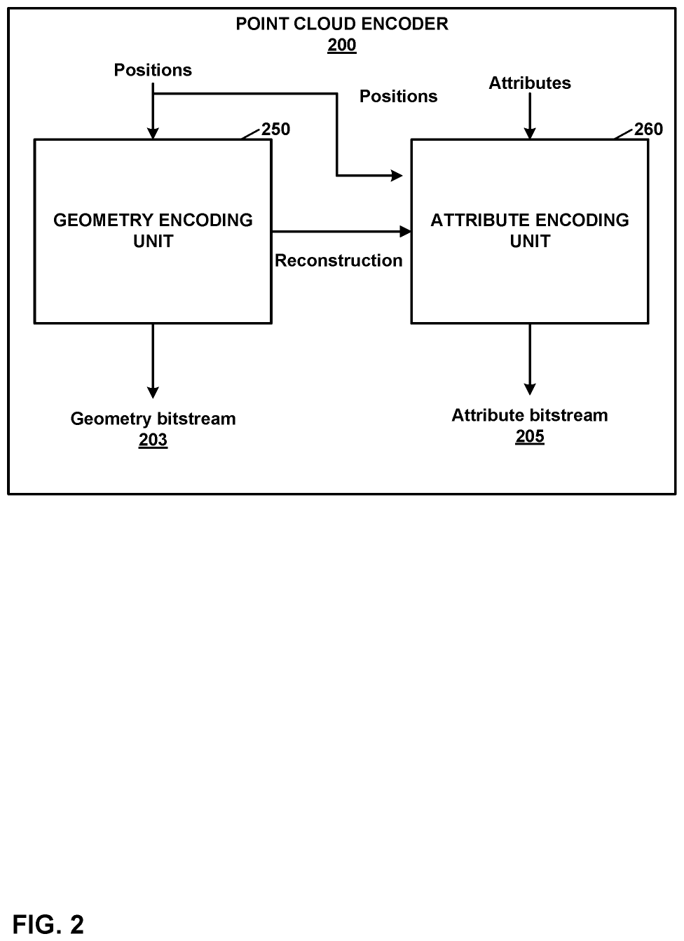

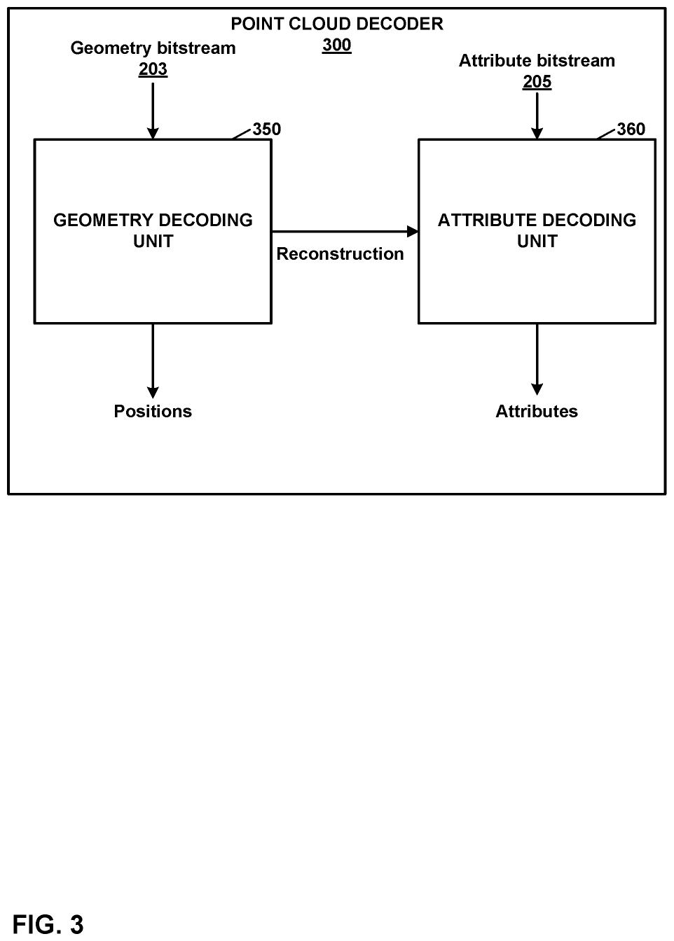

FIG. 2 provides a high-level overview of point cloud encoder 200. FIG. 3 provides a high-level overview of point cloud decoder 300. The modules shown are logical, and do not necessarily correspond one-to-one to implemented hardware, firmware, and/or code. In the example of FIG. 2, point cloud encoder 200 may include a geometry encoding unit 250 and an attribute encoding unit 260. In general, geometry encoding unit 250 is configured to encode the positions (e.g., coordinates) of points in the point cloud frame to produce geometry bitstream 203. Attribute encoding unit 260 is configured to encode the attributes of the points of the point cloud frame to produce attribute bitstream 205. As will be explained below, attribute encoding unit 260 may also use the positions, as well as the encoded geometry (e.g., the reconstruction) from geometry encoding unit 250 to encode the attributes.

As shown in the example of FIG. 2, point cloud encoder 200 may obtain a set of positions of points in the point cloud and a set of attributes. Point cloud encoder 200 may obtain the set of positions of the points in the point cloud and the set of attributes from data source 104 (FIG. 1). The positions may include coordinates (e.g., (x,y,z) coordinates) of points in a point cloud. The attributes may include information about the points in the point cloud, such as colors associated with points in the point cloud, normal vectors, reflectance information, or other attributes. Point cloud encoder 200 may generate a geometry bitstream 203 that includes an encoded representation of the positions of the points in the point cloud. Point cloud encoder 200 may also generate an attribute bitstream 205 that includes an encoded representation of the set of attributes.

In some examples of AI-based point cloud compression, geometry encoding unit 250 may be configured to downscale received geometry data by a certain amount, e.g., along the X-, Y-, and/or Z-axis, and encode the downscaled geometry data. In some examples, geometry encoding unit 250 may include a series of sets of downscaling and encoding task units that, as a unit, each downscale and encode the geometry data by a certain amount, then pass the downscaled and encoded geometry data to a subsequent task unit. In other examples, geometry encoding unit 250 may include a series of downscaling stages that each downscale the geometry data, then a set of one or more encoding task units that encode the downscaled geometry data.

In one example, geometry encoding unit 250 may downscale input geometry data (e.g., an octree) by a factor of 8: a factor of 2 along the X-axis, a factor of 2 along the Y-axis, and a factor of 2 along the Z-axis. Such downscaling may be performed by artificial intelligence/machine learning (AI/ML) unit, such as a neural network. In some examples, attribute encoding unit 260 may perform similar downscaling on attribute values. Additional details regarding examples of such downscaling are discussed below.

In the example of FIG. 3, point cloud decoder 300 may include a geometry decoding unit 350 and an attribute decoding unit 360. In general, geometry decoding unit 350 is configured to decode the geometry bitstream 203 to recover the positions of points in the point cloud frame. Attribute decoding unit 360 is configured to decode the attribute bitstream 205 to recover the attributes of the points of the point cloud frame. As will be explained below, attribute decoding unit 360 may also use the positions from the decoded geometry (e.g., the reconstruction) from geometry decoding unit 350 to encode the attributes.

In some examples, geometry decoding unit 350 may decode a value indicating an amount of upscaling to be applied to the geometry data (e.g., in situations where point cloud encoder 200 performed downscaling). Furthermore, geometry decoding unit 350 may both decode and upscale the geometry data, where the amount of upscaling may correspond to the decoded value. In some examples, geometry decoding unit 350 may include a sequence of sets of units including both decoding and upscaling units, where the number of sets is equal to the decoded value representing the amount of upscaling. In some examples, geometry decoding unit 350 may include one or more decoding units, then a sequence of sets of upscaling units, where the number of sets is equal to the decoded value representing the amount of upscaling. In some examples, geometry decoding unit 350 may further reconstruct a point cloud geometry using the decoded and upscaled point cloud geometry data.

The various units of FIG. 2 and FIG. 3 are illustrated to assist with understanding the operations performed by point cloud encoder 200 and point cloud decoder 300. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

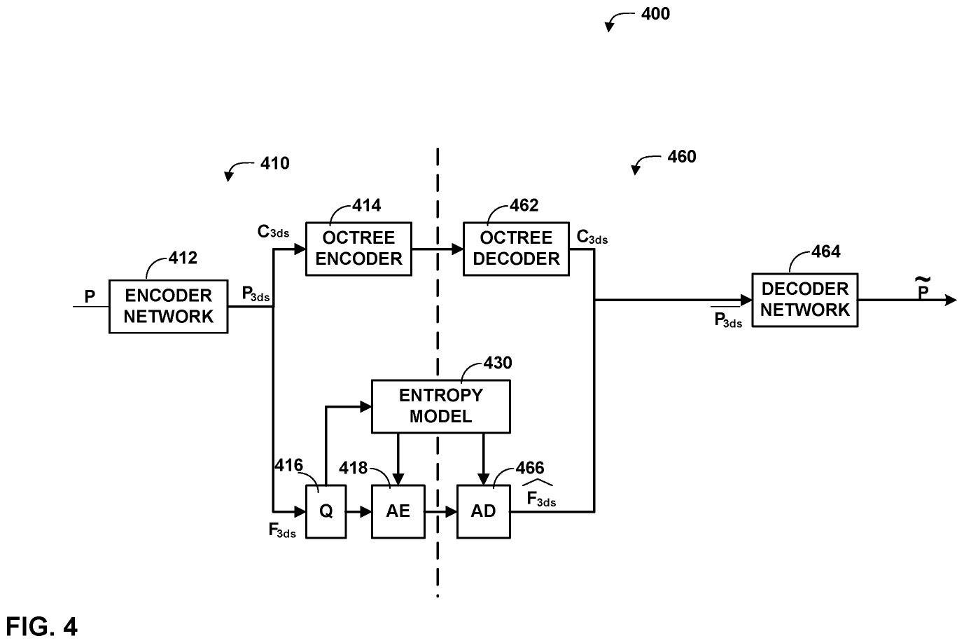

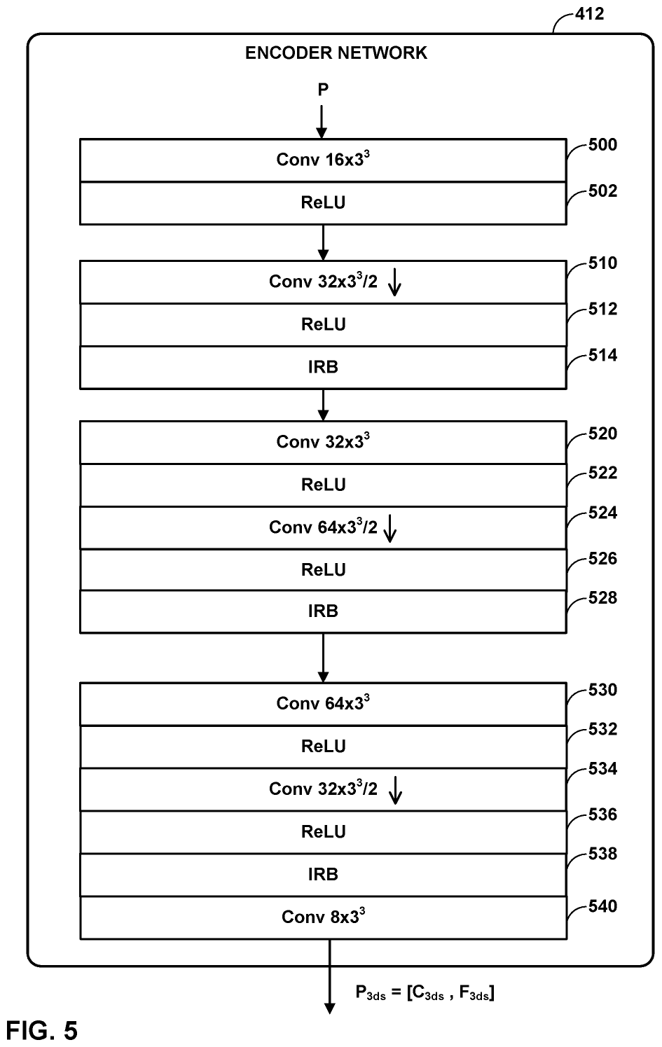

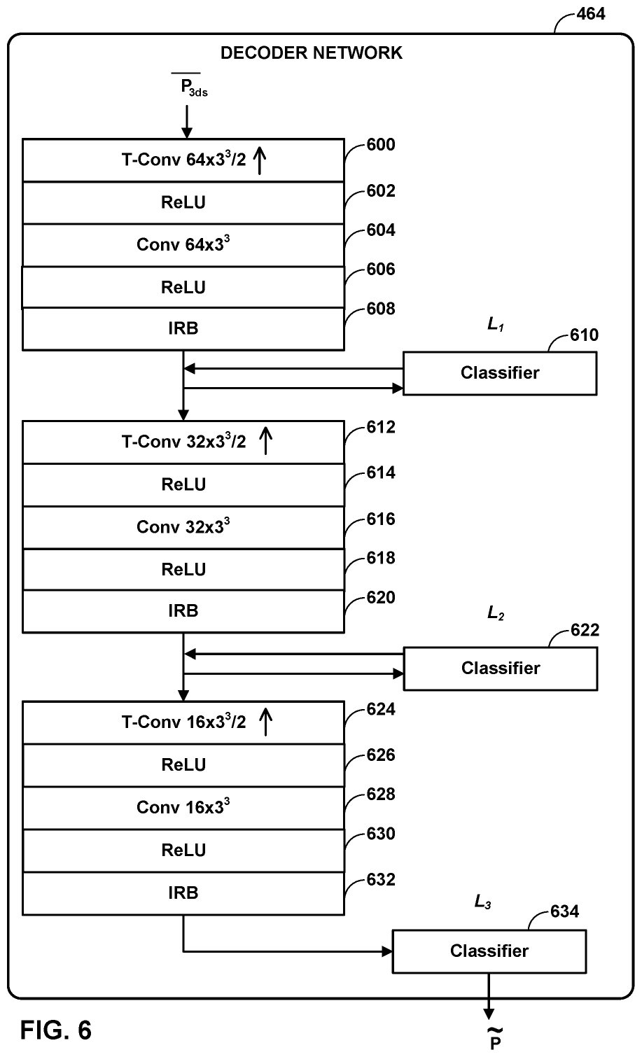

One example system model for AI-based (e.g., deep learning based) point cloud compression is shown in FIG. 4. More detailed examples of encoder network 412 and decoder network 464 are shown in FIG. 5 and FIG. 6, respectively.

In FIG. 4, system model 400 shows both an AI-based point cloud encoder 410 and an AI-based point cloud decoder 460. AI-based point cloud encoder 410 may be one example of point cloud encoder 200 (see FIG. 1 and FIG. 2). AI-based point cloud decoder 460 may be one example of point cloud decoder 300 (see FIG. 1 and FIG. 3). System model 400 is configured for intra prediction (I frame) encoding and decoding. However, the techniques of this disclosure may also be used in inter prediction encoding and decoding, for both uni-prediction (e.g., P frames) and bi-prediction (e.g., B frames).

AI-based point cloud encoder 410 includes an encoder network 412, an octree encoder 414, a quantizer (Q) 416, an arithmetic encoder (AE) 418, and an entropy model 430. At a high level, encoder network 412 is configured to use convolutional auto-encoders. Encoder network 412 may receive a sparse tensor (P) as an input. Sparse tensor P represents the input point cloud frame and includes a set of coordinates (C) and their associated learned features (F). That is P=[C, F]. At the input, F may be an all-ones vector representing occupancy. In the example of FIG. 4, encoder network 412 may be configured to downscale the point cloud three times to generate a downscaled tensor P_{3ds}. The downscaled tensor P_{3ds} includes downscaled coordinates C_{3ds} and associated features F_{3ds}. That is, each of the coordinates in C_{3ds} includes an associated feature value in F_{3ds}. While the examples of this disclosure show three-times (8×) downscaling in encoder network 412, and corresponding 3-times upscaling in decoder network 464, more or fewer levels of downscaling and upscaling may be used. Octree encoder 414 is configured to encode downscaled coordinates C_{3ds} using lossless octree encoding techniques, such as that used in G-PCC. For example, octree encoder 414 may generate on octree based on the downscaled coordinates C_{3ds}. At each node of an octree, an occupancy is signaled (when not inferred) for one or more of its child nodes (up to eight nodes). Multiple neighborhoods are specified including (a) nodes that share a face with a current octree node, (b) nodes that share a face, edge or a vertex with the current octree node, etc. Within each neighborhood, the occupancy of a node and/or its children may be used to predict the occupancy of the current node or its children.

Quantizer 416 may be configured to quantize the downscaled learned features F_{3ds} give that such features are in floating point format. Once quantized, arithmetic encoder 418 may be configured to arithmetically encode the quantized features F_{3d} using learned entropy model 430.

AI-based point cloud decoder 460 includes octree decoder 462, decoder network 464, arithmetic decoder (AD) 466, and entropy model 430. Octree decoder 462 receives the encoded octree from the encoded bitstream produced by octree encoder 414 and recovers downscaled coordinates C_{3ds}. Arithmetic decoder 466 receives the encoded features F_{3ds} from the encoded bitstream and decodes the encoded features using entropy model 430. Arithmetic decoder 466 recovers learned features [symbol] . Learned features [symbol] are marked with a hat as the quantization and arithmetic coding process may introduce some loss.

The downscaled coordinates C_{3ds} and learned features [symbol] are provided to decoder network 464 in the form of tensor P̅_̅{̅3̅d̅s̅}̅. That is P̅_̅{̅3̅d̅s̅}̅={C_{3ds}, [symbol] }. Decoder network 464 hierarchically reconstructs the point cloud \tilde{P}. For example, decoder network 464 may use three upsampling (also called upscaling) stages where binary classification is employed to reconstruct the occupied voxels. Decoder network 464 may use three binary cross-entropy loss functions for this purpose.

This disclosure interchangeably uses the terms “downscale” and “downsample.” This disclosure also interchangeably uses the terms “upscale” and “upsample.” The overall framework can be viewed as a transmission system, compression pipeline, or a deep learning model. In terms of a transmission system, elements before the bitstream generation may be referred to as forming part of a “transmitter” or “encoder” and elements after the bitstream may be referred to as forming part of a “receiver” or “decoder.” In terms of a deep learning model, encoder network 412 may be viewed as a multi-scale feature extractor, whereas decoder network 464 can be viewed as a progressive upscaling network with hierarchical reconstruction of the point cloud.

FIG. 5 is a block diagram illustrating an example encoder network 412 of FIG. 4 in accordance with the techniques of this disclosure. As described above, the input to encoder network 412 is a sparse tensor P that includes coordinates C and features F. In FIG. 5, the nomenclature Conv c×n³ refers to a convolution with c output channels and an n×n×n kernel size. As one example, convolution layer 500 (Conv 16×3³) performs convolution with a 3×3×3 kernel size and has 16 output channels. ReLU refers to a rectified linear unit. IRB refers to an Inception-Residual Block. The IRBs may include multiple convolution layers. Convolution layers with down arrows indicate two times downscaling. For example, convolution layer 510 performs a convolution with a 3×3×3 kernel size, has 32 output channels, and downscales the input coordinates and corresponding features by two times.

In general, a 3-dimensional (3D) convolution as used in FIG. 5, is configured to handle data with three spatial dimensions, such as the positions of points in a point cloud (e.g., the point cloud geometry). Each point may be represented by an (x,y,z) coordinate. 3D convolutions use a 3D filter (also called a 3D kernel). In 3D convolution, the filter itself is a three-dimensional block of weights. For example, instead of having a 2D filter of size 3×3 used in 2D convolutions, a 3D convolution may have a 3D filter of size 3×3×3. This 3D filter slides (or convolves) across the 3D input volume.

A 3D convolution operation involves computing a dot product between the 3D filter and the sections of the input volume the convolution operation covers at each step. For each position, the filter aligns with a 3D region of the input, multiplies the weights of the 3D kernel with the corresponding input values element-wise, and sums these products to produce an output value.

The output of a 3D convolution is a 3D volume that represents the convolved features extracted from the input volume. This process may be repeated with multiple 3D filters to extract different types of features from the input. The stride in 3D convolution refers to the number of steps the filter moves in each of the three dimensions after each operation. A stride of 1 in all three dimensions means the filter moves one unit at a time along each axis.

In some examples, padding can also be applied in 3D convolution, involving adding layers of zeros around the input volume in all three dimensions. Padding may help control the size of the output volume and allow for more flexible architectural designs.

A ReLU is a type of activation function used in neural networks, particularly in the hidden layers. A ReLU function outputs the input directly if it is positive; otherwise, the ReLU function outputs zero. The ReLU function is piecewise linear, with a non-linear breakpoint at zero. A ReLU function is non-linear, which may be helpful for learning complex patterns in the data.

In some examples, a ReLU activation can lead to sparse representations, which can be advantageous in terms of computation and memory usage. Since the ReLU function outputs zero for all negative inputs, many neurons in the network can effectively be “turned off.” The gradient of the ReLU function is 1 for all positive inputs, which helps in alleviating the vanishing gradient problem encountered with other activation functions. However, for inputs less than zero, the gradient is zero, which can lead to neurons that never activate (a problem known as “dying ReLU”).

Due to the “dying ReLU” problem, several variants of the ReLU function have been proposed, including a Leaky ReLU function or a parametric ReLU (PRELU). A Leaky ReLU introduces a small, positive gradient for negative inputs. A PRELU is similar to Leaky ReLU, but the coefficient of the negative part is learned during the training. A Leaky ReLU or PRELU may be used in place of a ReLU in any example of this disclosure.

An Inception-Residual (Inception-ResNet) block (IRB) in FIG. 5 is a neural network that combines the concepts of Inception blocks, which are used for feature extraction, with Residual connections (ResNet), which may facilitate deeper network architectures by addressing the vanishing gradient problem. The hybrid design of an IRB leverages the strengths of both architectures to improve performance.

Inception blocks contain multiple parallel paths of convolutional operations with filters of varying sizes (e.g., 1×1, 3×3, 5×5) and pooling operations. This design allows the IRB to capture and process information at different scales or resolutions simultaneously, enabling the network to adapt to a wide range of input patterns.

Residual connections (or shortcut connections) in ResNet architectures add the input of a block directly to its output, effectively allowing the network of an IRB to learn residual functions with reference to the layer inputs. This technique helps in combating the vanishing gradient problem as it provides an alternative path for gradient flow during backpropagation, enabling the successful training of much deeper networks.

An Inception-Residual block integrates these two concepts by incorporating Inception-style parallel convolutional paths within a block and then using a residual connection to add the input of the block to the output of the block. The output from the parallel paths is typically concatenated and then may go through additional processing (e.g., a 1×1 convolution) before being added to the input of the block through the residual connection.

Returning to FIG. 5, the convolution layers shown may be sparse convolutions. A sparse convolution may better leverage the sparse nature of a point cloud and may allow for complexity reduction by applying computations only on occupied voxels (e.g., voxels including one or more points). Convolution layer 500 performs a 3×3×3 convolution, with 16 output channels to generate an initial set of features F from the input coordinates C of sparse tensor P. ReLU function 502 is a non-linear activation function that operates on the output of convolution layer 500.

As shown in FIG. 5, encoder network 412 is configured to downscale the coordinates in sparse tensor P. FIG. 5 shows an example of progressive downscaling where three different layers (i.e., convolution layer 510, convolution layer 524, and convolution layer 534) performing 2× downscaling. As such, the coordinates of input tensor P are downscaled a total of three times, thus achieving an 8× reduction in the number of coordinates in output tensor P_{3ds}. That is, C_{3ds} has 8× fewer coordinates than the input coordinates C. F_{3ds} is a feature vector having a feature for each coordinate in C_{3ds}.

Convolution layer 510 operates on the output of ReLU 502 and performs the 2× downscaling of the coordinates. Convolution layer 510 is followed by ReLU 512 and IRB 514. As described above, an IRB block may include a plurality of convolution layers and may be configured to generate additional features based on the coordinates. The general architecture of convolution layer 500, ReLU layer 502, convolution layer 510 (downscaling), ReLU 512, and IRB 514 is repeated two more times in the architecture shown in FIG. 5. That is, convolution layer 520, ReLU layer 522, convolution layer 524 (downscaling), ReLU 526, and IRB 528 operate on the one-time downscaled coordinates and corresponding features output by IRB 514. Similarly, convolution layer 530, ReLU layer 532, convolution layer 534 (downscaling), ReLU 536, and IRB 538 operate on the two-times downscaled coordinates and corresponding features output by IRB 528. Encoder network 412 may include a final output convolution layer 540 that outputs the downscaled tensor P_{3ds}.

In general, the structure of encoder network 412 is configured with convolutional layers to process sparse tensors which are represented using geometry coordinates C and feature vectors F. Encoder network 412 progressively downscales coordinates C to multiple scales by implicitly learning and embedding the distribution of positively occupied voxels in the volumetric representation of a point cloud into F features.

Encoder network 412 may use sparse convolutions for low-complexity tensor processing. IRBs are used for efficient feature extraction. IRB blocks 514, 526, and 538 are positioned after each downscaling process (e.g., convolution layers 510, 524, and 534). Convolution layers 510, 524, and 534 may be configured to perform the downscaling by applying a convolution with a stride of two to halve the scale of each geometric dimension (e.g., (x,y,z)). Convolution layers 510, 524, and 534 may have similar structures, but uses different parameters in terms of kernel size and output feature length, as shown in FIG. 5. Convolution layers 510 may apply fewer channels, relative to convolution layer 524, to reduce computational cost, while convolution layers 534 may use fewer channels to reduce the size of the output features.

FIG. 6 is a block diagram illustrating an example decoder network 464 of FIG. 4 in accordance with the techniques of this disclosure. Decoder network 464 is configured to perform a reciprocal process to that of encoder network 412 to recover the original geometry (e.g., coordinates of points) of the encoded point cloud.

The input to decoder network 464 is a sparse tensor P_{3ds} generated by encoder network 412, where P_{3d} includes coordinates C_{3ds} and features F_{3ds}. In FIG. 6, convolution layers with up arrows indicate two times upscaling. For example, convolution layer 600 performs a convolution with a 3×3×3 kernel size, has 64 output channels, and upscales the input coordinates and corresponding features by two times. ReLU function 602 is a non-linear activation function that operates on the output of convolution layer 600.

As shown in FIG. 6, decoder network 464 is configured to upscale the downscaled coordinates in sparse tensor P_{3ds}. FIG. 6 shows an example of progressive upscaling where three different layers (i.e., convolution layer 600, convolution layer 612, and convolution layer 624) perform 2× upscaling. As such, the coordinates of input tensor P_{3ds} are upscaled a total of three times, thus achieving an 8× increase in the number of coordinates in output point cloud P. That is, the coordinates in point cloud P have 8× more coordinates than the input coordinates C_{3ds}.

Convolution layer 604 operates on the output of ReLU 602. Convolution layer 604 is followed by ReLU 606 and IRB 608. As described above, an IRB block may include a plurality of convolution layers and may be configured to generate additional features based on the coordinates. Classifier 610 then operates on the output of IRB 608. Classifier 610 reconstructs geometry details (e.g., the occupancy of voxels with points) by pruning false voxels and extracting occupied voxels using binary classification according to loss function L1. Classifier 610 may use a hierarchical, coarse-to-fine refinement. Classifier 610 applies binary classification to determine whether generated voxels are occupied or not, and may use a sparse convolutional layer to generate a probability of voxel-being occupied after consecutive convolutions.

The general architecture of convolution layer 600 (upscaling), ReLU layer 602, convolution layer 604, ReLU 606, IRB 608, and classifier 610 is repeated two more times in the architecture shown in FIG. 6. That is, convolution layer 600 (upscaling), ReLU layer 602, convolution layer 604, ReLU 606, IRB 608, and classifier 610 operate on two-times downscaled coordinates (due to the upscaling above) and corresponding features. Similarly, convolution layer 612 (upscaling), ReLU layer 614, convolution layer 616, ReLU 618, IRB 620, and classifier 622 (using loss function L2) operate on the one-times downscaled coordinates (e.g., due to the upscaling above) and corresponding features output by convolution layer 612. Convolution layer 624 (upscaling), ReLU layer 626, convolution layer 628, ReLU 630, IRB 632, and classifier 634 (using loss function L3) operate on the coordinates at the original scale (e.g., due to the upscaling above) and corresponding features output by convolution layer 624. Classifier 634 outputs the reconstructed point cloud P. In general, in decoder network 464, reconstruction from the preceding lower scale will be upscaled by augmenting feature attributes for finer geometry refinement at the current layer.

Positional encoding is one technique used in deep learning models, particularly in the field of natural language processing (NLP), where the order of elements in a sequence, such as words in a sentence, is important. Positional encoding has been used to provide a deep learning model with information about the positions of elements within the sequence, which helps the model differentiate between different elements based on their positions.

In many deep learning architectures, like transformers, sequences are typically processed in parallel, which means the model does not inherently understand the order of the elements. Positional encoding is introduced to address this issue. Positional encoding may be added to the input embeddings of the sequence and is learned along with other parameters during the training process. Positional encoding also used in various other domains, such as computer vision tasks and more broadly in transformer-based architectures.

In computer vision, convolutional neural networks (CNNs) may be used to process 2D images. CNNs are typically designed to handle grid-like data, such as images, where the spatial arrangement of pixels matters. However, unlike sequences in NLP, the concept of order is not as inherent in images. To incorporate positional information, positional encoding can be added to the input image data. One method is to use a grid of positional encodings that are concatenated to the image features. Here the (x,y) location of the pixels are used as position to create a higher dimensional positional encoding.

For example, in image generation, the input might be a flattened version of an image where the spatial structure is lost. Positional encoding can be added to represent the spatial layout of the pixels. Similarly, in video analysis, each frame can be treated as a “position” in a sequence, and positional encoding helps the model understand the temporal order of frames. Different types of positional encoding techniques are described below.

Sine and Cosine Positional Encoding: One type of positional encoding is sine and cosine positional encoding, which is based on the idea that it's possible to represent positions using sine and cosine functions of different frequencies. Each dimension of the positional encoding corresponds to a different frequency, and the combination of these dimensions creates a unique pattern for each position.

Mathematically, the positional encoding for position “pos” and dimension “i” can be represented as:

$$PE ( pos , 2 i ) = sin ( \frac{pos}{{10000}^{\frac{2 i}{{d}_{model}}}} )$$

$$PE ( pos , 2 i + 1 ) = cos ( \frac{pos}{{10000}^{\frac{2 i}{{d}_{model}}}} )$$

Where “pos” is the position in the sequence, “i” is the dimension index, and d_{model} is the dimensionality of the model's embeddings.

The intuition behind this formula is that lower-frequency terms capture long-range relationships between positions, while higher-frequency terms capture short-range relationships. The scaling factor 10000 is chosen empirically to ensure that the positional encodings have distinct values for different positions.

In addition to the sine and cosine positional encoding commonly used in transformer-based models, there are several other types and variations of positional encodings that have been proposed in the field of deep learning, depending on the specific requirements of the task or architectural choices. Examples are described below.

Learned Positional Encodings: Learned positional encodings involve treating the positional embeddings as trainable parameters within the model, allowing the network to adaptively learn the best representations for positions during training. This approach is not limited to any specific mathematical function and can be customized to the task.

Linear Positional Encoding: Linear positional encodings assign a simple linear function of the position to represent positional information. For example, the positional embedding might be a sequence of consecutive integers representing the position of each element. This type of encoding is particularly straightforward but may not capture complex positional relationships.

Radial Basis Function (RBF) Positional Encoding: RBF positional encoding uses radial basis functions centered at each position in the sequence. The idea is to create a basis of Gaussian-like functions that vary in response to the position. This can capture local positional information effectively.

Fermi-Dirac Function Positional Encoding: Fermi-Dirac function positional encoding is inspired by quantum mechanics and uses Fermi-Dirac distribution functions. A Fermi-Dirac function models positional relationships with a smooth, sigmoid-like curve, which can be useful for tasks that involve gradual changes in positional importance.

Hybrid Positional Encoding: Some models employ a combination of different positional encoding methods. For instance, some models might use sine and cosine positional encodings for low-frequency information and linear or learned positional encodings for high-frequency information. This hybrid approach aims to capture both short and long-range positional dependencies.

Relative Positional Encoding: Relative positional encodings are designed to capture the relative distances between elements in a sequence, rather than absolute positions. Relative positional encodings are often used in tasks like machine translation, where the model is configured to understand how elements relate to each other regardless of their absolute position in the input.

Image Grid Positional Encoding: In computer vision tasks, especially when using transformers for image analysis, a grid-like positional encoding is used to represent the spatial layout of image pixels. Each pixel in the grid is associated with a unique positional embedding.

The choice of positional encoding depends on the specific task and the nature of the data. Some types may work better for certain tasks or data distributions, while others may be more computationally efficient.

After computing the positional encodings, the encoding may be added element-wise to the input embeddings of the sequence before feeding them into the model. This addition ensures that the model has information about the positions of the elements, allowing it to differentiate between elements based on their order.

This disclosure describes techniques where one or more positional encoding layers, such as those described before are added into the encoder network (e.g., encoder network 412) and decoder network (e.g., decoder network 464) for AI-based point cloud compression. As will be described below, the positional encoding layers create additional, higher-dimensional feature that are generated from the currently processed coordinates. The features are higher-dimensional relative to other feature tensors generated by the encoder or decoder network. These additional, higher-dimensional feature attributes are combined (e.g., concatenated) to the feature tensors generated by the other layers of the encoder network and decoder network. By increasing the dimensionality of the feature tensors generated by the networks with the positional encoding layers, the techniques of this disclosure may improve the efficiency of the point cloud compression.

For example, testing has shown that adding positional encoding layers to both a point cloud encoder and a point decoder for an example AI-based point cloud compression method (e.g., PCGCv2) may improve the compression results by up to 4% BD-rate (Bjontegaard Delta-rate) savings. Testing has shown that the concept of positional encoding remains consistent even when applied to non-NLP domains, such as in point cloud compression. The positional encoding techniques of this disclosure may enhance a the ability of an AI-based point cloud compression model to handle sequences where order matters, better ensuring the AI-based point cloud compression model captures meaningful relationships between elements based on their positions.

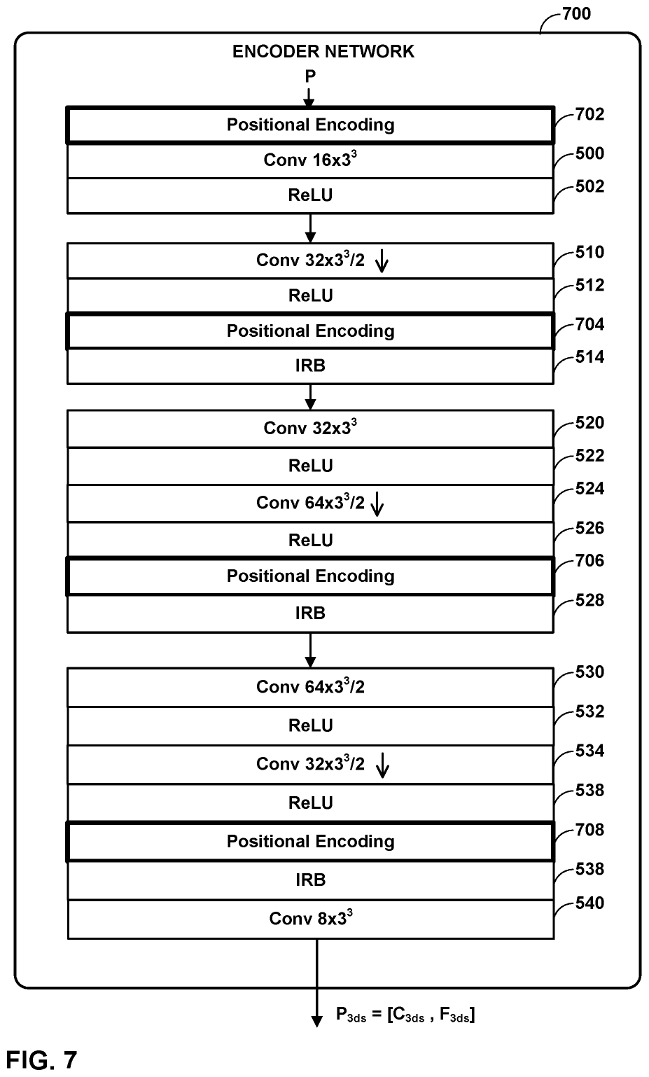

FIG. 7 is a block diagram illustrating an example encoder network 700 with positional encoding in accordance with the techniques of this disclosure. The convolutional layers, ReLU functions, and IRB layers of encoder network 700 are the same as those shown in encoder network 412 in FIG. 5. Just like the encoder network 412, encoder network 700 may include more or fewer layers in different combinations, and with more or fewer convolution layers for downscaling. In some examples, encoder network 700 may not have any layers for downscaling.

At a high-level, encoder network 700 (which may be part of point cloud encoder 200) is configured to receive a frame of point cloud data (e.g., sparse tensor P) and encode coordinates C of a geometry of the frame of point cloud data using a deep learning network. In FIG. 7, the deep learning network (i.e., encoder network 700) is a convolutional neural network. Encoder network 700 includes one or more layers (e.g., convolutional layers and/or IRB blocks) configured to generate first features for the coordinates of the geometry. Encoder network 700 includes at least one positional encoding layer (e.g., positional encoding layer 702, 704, 706, and/or 708) configured to generate second features for the coordinates of the geometry. As will be described below, the positional encoding layer may be configured to combine the first features with the second features to generate higher-dimensional features. Encoder network 700 may output an output tensor (P_{3ds}) comprising coordinates (C_{3ds}) and the higher-dimensional features (F_{3ds}).

In one example, positional encoding layers 702, 704, 706, and 708 are implemented using learned positional encoding. In one example, the learned positional encoding is implemented using a 1×1×1 convolutional layer that is configured to map the coordinates C={(x, y, z)} coordinates into higher dimensional learned features (e.g., 128 dimensional).

A learning-based positional encoding layer is an alternative to the traditional fixed positional encoding, which relies on predefined mathematical functions (e.g., sine and cosine functions) to represent the position information in sequences. In a learning-based approach, the positional encoding is learned as part of a model training process. Instead of using fixed positional encodings, the model assigns learnable embeddings to each position in the sequence. These position embeddings are treated as additional parameters that the model updates during training, just like other weights in the network.

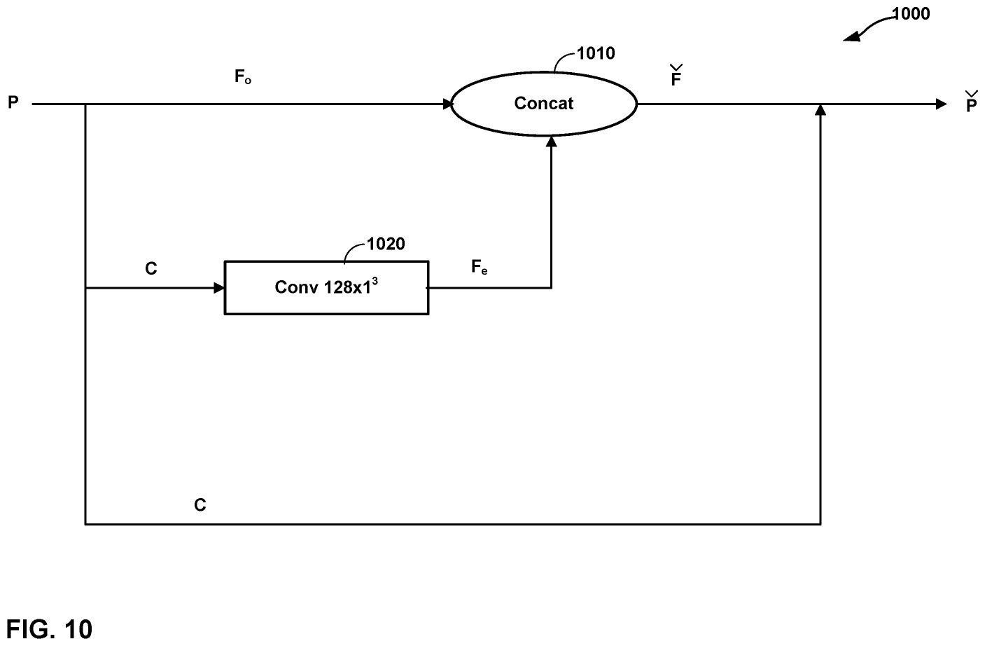

During the forward pass of the training process, the model processes the input sequence, including the position embeddings. During training, the loss is calculated, and gradients are backpropagated through the network, including the positional embeddings. Over time, the positional embeddings are adjusted to contain meaningful position information that aids the model in capturing relationships between points based on their positions/coordinates. The advantage of a learning-based positional encoding is that it allows the model to adapt to the specific task and data distribution. More details about the learned positional encoding is described below with respect to FIG. 10.

The example of FIG. 7 includes four positional encoding layers 702, 704, 706, and 708. Positional encoding layer 702 is positioned at the start of encoder network 700. Positional encoding layer 702 is configured to add positional encoding to the tensor before processing. Positional encoding layer 702 may be considered a first positional encoding layer that operates on an input (P) of the deep learning network (encoder network 700). While, the example of FIG. 7 shows the use of four positional encoding layers, the techniques of this disclosure may include any number of positional encoding layers, including as few as one positional encoding layer.

Encoder network 700 may include at least one positional encoding layer (e.g., a second positional encoding layer) that operates on the downscaled coordinates. In the example of FIG. 7, encoder network 700 includes three additional positional encoding layers 704, 706, and 708 that operate on downscaled coordinates. FIG. 7 shows that positional encoding layers 704, 706, and 708 are positioned between a convolutional layer that performs the downscaling (e.g., convolutional layer 510) and before an IRB block (e.g., IRB 514). Positioning the positional encoding layers between the downscaling convolution layer and an IRB allows for positional encoding to be performed after the scale is changed, but before most of the feature extractions/convolutions are performed in IRB so that such convolutions in the IRB can factor in the positional embedding.

FIG. 7 shows that positional encoding layers 704, 706, and 708 are positioned between a ReLU function and the IRB block. In other examples, positional encoding layers 704, 706, and 708 may be positioned between a downscaling convolution layer and the ReLU function. In still other examples, positional encoding layers 704, 706, and 708 may be positioned between layers within an IRB. In addition, positional encoding layers 704, 706, and 708 need not be positioned in the same general location in each downscaling sections of encoder network 700, but could be placed in differing positions in each downscaling section of encoder network 700.

Accordingly, in the example of FIG. 7, encoder network 700 includes three layers (e.g., convolution layer 510, convolution layer 524, and convolution layer 534) configured to progressively downscale the coordinates of the geometry to generate first downscaled coordinates, second downscaled coordinates, and third downscaled coordinates. In this example, the output tensor (P_{3ds}) comprises the third downscaled coordinates (C_{3ds}) and the higher-dimensional features (F_{3ds}). Encoder network 700 includes a first positional encoding layer 702 that operates on an input (P) of the encoder network 700, a second positional encoding layer 704 that operates on the first downscaled coordinates, a third positional encoding layer 706 that operates on the second downscaled coordinates, and a fourth positional encoding layer 708 that operates on the third downscaled coordinates. As described above, at least one of the second positional encoding layer 704, the third positional encoding layer 706, or the fourth positional encoding layer 708 is positioned between a layer configured to downscale the coordinates (e.g., convolution layer 510) and an inception-residual block (e.g., IRB 514).

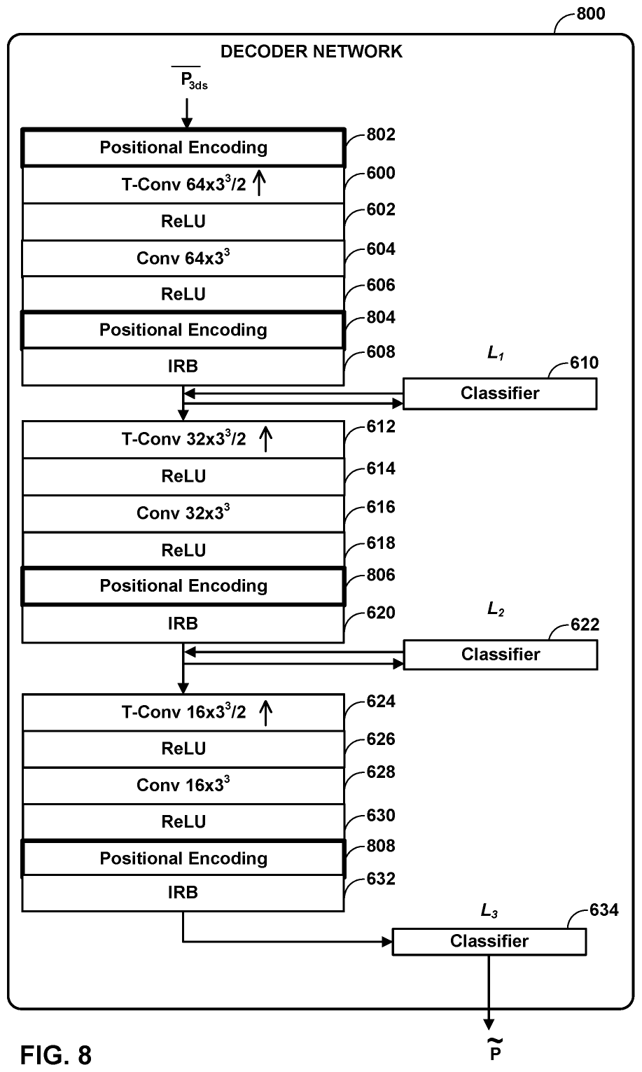

FIG. 8 is a block diagram illustrating an example decoder network 800 with positional encoding in accordance with the techniques of this disclosure. The convolutional layers, ReLU functions, IRB layers, and classifiers of decoder network 800 are the same as those shown in decoder network 464 in FIG. 6. Just like the decoder network 464, decoder network 800 may include more or fewer layers in different combinations, and with more or fewer convolution layers for upscaling. In examples where encoder network 700 does not perform downscaling, decoder network 800 would not have any layers for upscaling.

At a high-level, decoder network 800 (which may be part of point cloud decoder 300) is configured to perform a reciprocal process to that of encoder network 700. Decoder network 800 may receive a frame of encoded point cloud data (P_{3ds}={C_{3ds}, F_{3ds}}, where the encoded point cloud data includes an input tensor comprising encoded coordinates and corresponding features. Point cloud decoder 300 may decode coordinates of a geometry of the frame of the encoded point cloud data using a deep learning network (e.g., decoder network 800) and the input tensor to generate decoded coordinates.

Decoder network 800 network includes one or more layers configured to generate first features for the coordinates of the geometry (e.g., convolution layers and/or IRBs), at least one positional encoding layer (e.g., positional encoding layers 802, 804, 806, and/or 808) configured to generate second features for the coordinates of the geometry and combine the first features with the second features to generate higher-dimensional features. Decoder network 800 may further include one or more layers (e.g., classifiers 610, 622, and/or 634) configured to classify the higher-dimensional features to generate the decoded coordinates. Point cloud decoder 300 may output the decoded coordinates in a decoded point cloud (P).

As with encoder network 700, positional encoding layers 802, 804, 806, and 808 of decoder network 800 may be implemented using learned positional encoding. In one example, the learned positional encoding is implemented using a 1×1×1 convolutional layer that is configured to map the coordinates C={(x, y, z)} coordinates into higher dimensional learned features (e.g., 128 dimensional).

The example of FIG. 8 includes four positional encoding layers 802, 804, 806, and 808. Positional encoding layer 802 is positioned at the start of decoder network 800. Positional encoding layer 802 is configured to add positional encoding to the input tensor before processing. Positional encoding layer 802 may be considered a first positional encoding layer that operates on an input (P) of the deep learning network (decoder network 800). While, the example of FIG. 8 shows the use of four positional encoding layers, the techniques of this disclosure may include any number of positional encoding layers, including as few as one positional encoding layer.

Decoder network 800 may include at least one positional encoding layer (e.g., a second positional encoding layer) that operates on the upscaled coordinates. In the example of FIG. 8, decoder network 800 includes three additional positional encoding layers 804, 806, and 808 that operate on upscaled coordinates. FIG. 8 shows that positional encoding layers 804, 806, and 808 are positioned between a convolutional layer that performs the upscaling (e.g., convolutional layer 600) and before an IRB block (e.g., IRB 608). Positioning the positional encoding layers between the upscaling convolution layer and an IRB allows for positional encoding to be performed after the scale is changed, but before most of the feature extractions/convolutions are performed in IRB so that such convolutions in the IRB can factor in the positional embedding.

FIG. 8 shows that positional encoding layers 804, 806, and 808 are positioned between a ReLU function and the IRB block. In other examples, positional encoding layers 804, 806, and 808 may be positioned between a upscaling convolution layer and an ReLU function. In still other examples, positional encoding layers 804, 806, and 808 may be positioned between layers within an IRB. In addition, positional encoding layers 804, 806, and 808 need not be positioned in the same general location in each upscaling sections of decoder network 800, but could be placed in differing positions in each upscaling section of decoder network 800.

Accordingly, in the example of FIG. 8, decoder network 800 includes three layers (e.g., convolution layer 600, convolution layer 612, and convolution layer 624) configured to progressively upscale the downscaled coordinates to generate first upscaled coordinates, second upscaled coordinates, and third upscaled coordinates. Decoder network 800 includes a first positional encoding layer 802 that operates on decoder network 800, a second positional encoding layer 804 that operates on the first upscaled coordinates, a third positional encoding layer 806 that operates on the second upscaled coordinates, and a fourth positional encoding layer 808 that operates on the third upscaled coordinates. As described above, at least one of the second positional encoding layer 804, the third positional encoding layer 804, or the fourth positional encoding layer 808 is positioned between a layer configured to upscale the downscaled coordinates (e.g., convolution layer 600) and an inception-residual block (e.g., IRB 608).

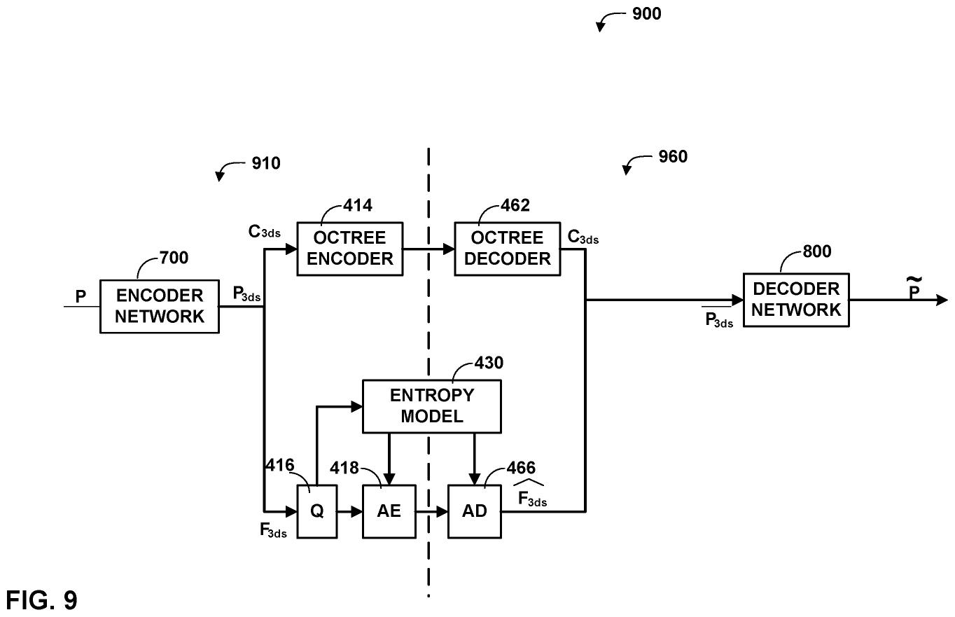

FIG. 9 is a block diagram illustrating an example system model 900 for AI-based point cloud compression with positional encoding that may perform the techniques of this disclosure. System model 900 shows both an AI-based point cloud encoder 910 and an AI-based point cloud decoder 960. AI-based point cloud encoder 910 may be one example of point cloud encoder 200 (see FIG. 1 and FIG. 2). AI-based point cloud decoder 960 may be one example of point cloud decoder 300 (see FIG. 1 and FIG. 3). System model 900 is configured for intra prediction (I frame) encoding and decoding. However, the techniques of this disclosure may also be used in inter prediction encoding and decoding, for both uni-prediction (e.g., P frames) and bi-prediction (e.g., B frames).

In general, system model 900 operates in the same manner as described above for system model 400 with respect to FIG. 4. However, point cloud encoder 910 uses encoder network 700 having one or more positional encoding layers. Likewise, point cloud decoder 960 uses decoder network 800 have one or more positional encoding layers. The process for octree encoding and decoding, as well as quantization and arithmetic coding remains the same.

For example, point cloud encoder 910 may be configured to perform octree encoding (e.g., using octree encoder 414) on the coordinates (C_{3ds}) of the output tensor produced by encoder network 700 to generate the encoded coordinates. Point cloud encoder 910 may further quantize (e.g., using quantizer 416) the higher-dimensional features (F_{3ds}) generated by encoder network 700 to generate quantized higher-dimensional features, and may arithmetically encode (e.g., using arithmetic encoder 418) the quantized higher-dimensional features of the output tensor using an entropy model (e.g., entropy model 430) to generate encoded higher-dimensional features. Point cloud encoder 910 may output the encoded coordinates and the encoded higher-dimensional features in an encoded bitstream.

Point cloud decoder 960 may perform octree decoding (e.g., using octree decoder 462) on encoded coordinates in an encoded bitstream to recover the encoded coordinates (C_{3ds}) in the input tensor. Point cloud decoder 960 may further arithmetically decode (e.g., using arithmetic decoder 466) encoded features in the encoded bitstream to recover the corresponding features ( [symbol] ) in the input tensor (P_{3ds}={C_{3ds}, [symbol] }).

FIG. 10 is a block diagram illustrating an example positional encoding layer in accordance with the techniques of this disclosure. Learned positional encoding layer 1000 is one example of learned positional encoding that uses a 1×1×1 filter kernel with 128 output channels (conv 128×13). Learned positional encoding layer 1000 receives a tensor P as input. P includes coordinates C and corresponding features Fₒ. Features Fₒ are the features generated from one or more previous layers of an encoder network or decoder network. That is, features Fₒ may be from any position within an encoder network or decoder network. Likewise, coordinates C may be coordinates at any level of downscaling or upscaling within an encoder network or decoder network.

Learned positional encoding layer 1000 includes a convolution layer 1020 that performs a 1×1×1 convolution with a 128 dimensional output. Convolution layer 1020 produces output features Fₑ from input coordinates C. That is, convolution layer 1020 is configured to map the C={(x, y, z)} coordinates into higher dimensional learned features (e.g., 128 dimensional) Fₑ. Concatenation unit 1010 concatenates features Fₒ with learned output features Fₑ to generate higher-dimensional features F̆. For example, if the input features Fₒ have a feature size of 64 and learned output features Fₑ have feature size of 128, the higher-dimensional features F̆ have a feature size of 192. In other examples, learned positional encoding layer may multiply input features Fₒ with learned output features Fₑ to produce higher-dimensional features F̆. Learned positional encoding layer 1000 then combines the input coordinates C with the higher-dimensional features F̆ to generate output tensor P̆, where P̆=[C, F̆].

The weights of convolutional layer 1020 may be learned during training. In effect, convolutional layer 1020 may behave similarly to a fully connected layer or a multi-layer perceptron (MLP). As such, in other examples, Learned positional encoding layer 1000 may use a fully connected layer or an MLP in place of convolution layer 1020. In a fully connected layer, each neuron or node is connected to every neuron in the previous layer and every neuron in the following layer. This structure allows the layer to integrate information from all the inputs received, making it capable of learning complex relationships in the data. An MLP is a type of feedforward neural network that includes at least three layers of nodes: an input layer, one or more hidden layers, and an output layer. Each node, or neuron, in one layer connects with a certain weight to every node in the following layer, making the network fully connected. The nodes in the hidden and output layers typically use a nonlinear activation function to process the input received from the previous layer.

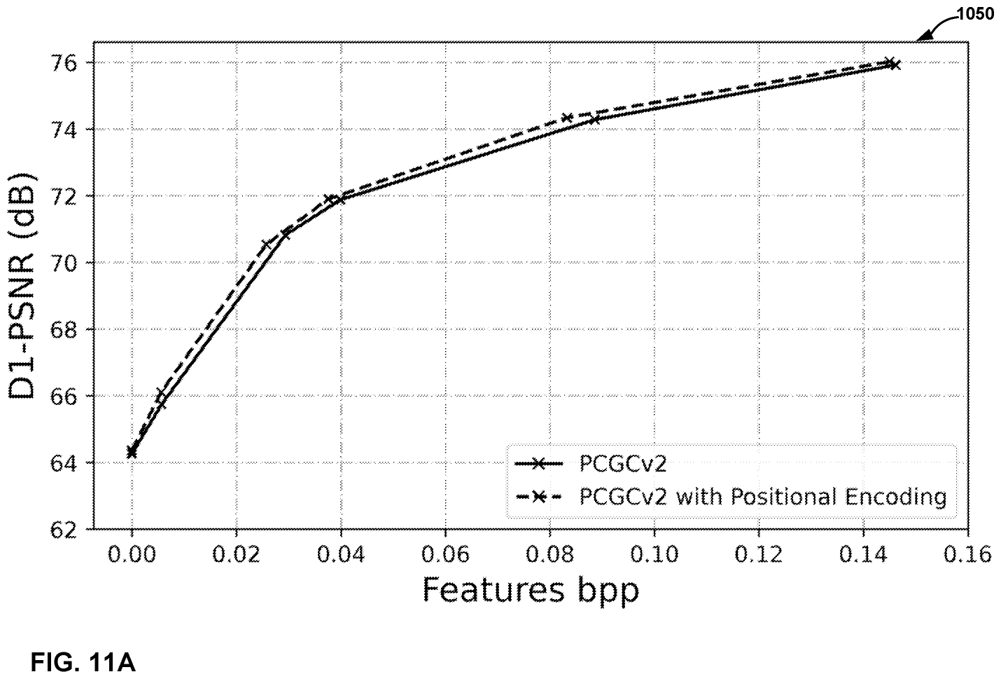

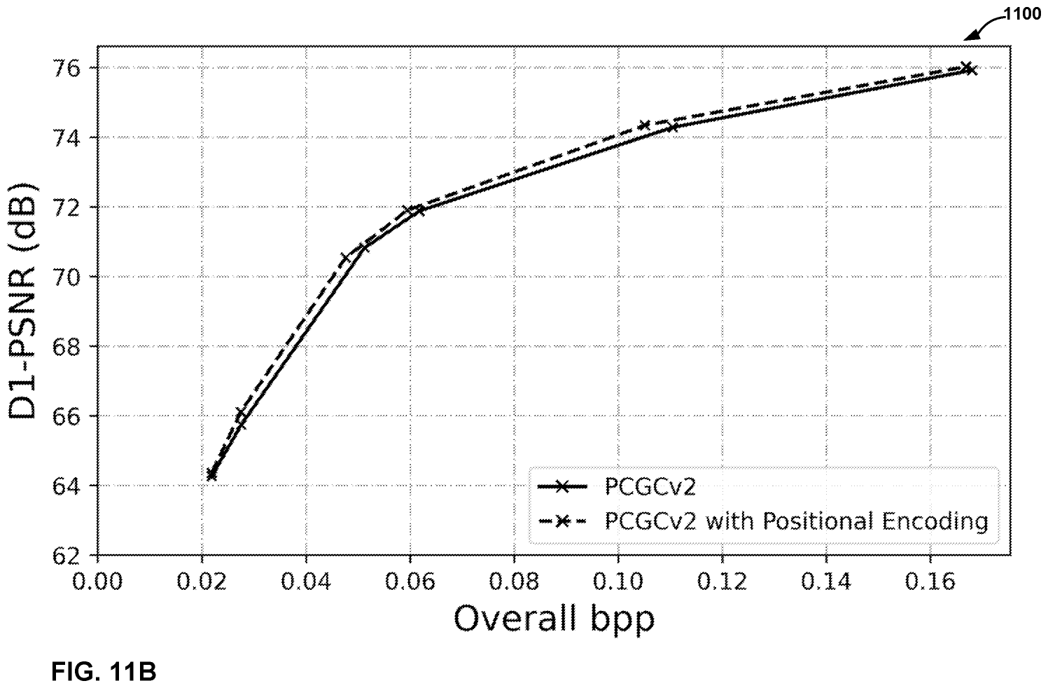

FIG. 11A shows a graph 1050 showing a test of compression efficiency of a features bitstream encoded in accordance with the techniques of this disclosure. FIG. 11B is a graph 1100 showing a test of compression efficiency of an overall bitstream encoded in accordance with the techniques of this disclosure. FIGS. 11A and 11B show rate-distortion (RD) curves of point cloud encoder output using the positional encoding techniques of this disclosure. Graphs 1050 and 1100 show clear improvement in the RD-curve by adding positional encoding to the network. This translates to about a 4% BD-rate savings.

### OTHER EXAMPLES

The following changes/flexibility can be added to any of the techniques described above in any combination.

In the examples of FIG. 7 and FIG. 8 above, a point cloud encoder network and a point cloud decoder network use a learning-based positional encoding layer. However, any positional encoding method can be employed. For example, the positional encoding may be any of a sine and cosine positional encoding layer, a linear positional encoding layer, a radial basis function positional encoding layer, a Fermi-Dirac positional encoding layer, a hybrid positional encoding layer, a relative positional encoding layer, or an image grid positional encoding layer. Some testing has shown that sine and cosine positional encoding has led to improved results over techniques that do not use any positional encoding.

In the examples of FIG. 7 and FIG. 8 above, the learned positional encoding uses a 1×1×1 convolution layer. However, a point cloud encoder or point cloud decoder may be configured to any number or types of layers to generate the positional embedding features. Meaning, point cloud encoder or point cloud decoder may be configured to use any neural network for learned positional encoding. One common type of neural network employed in positional encoding is a fully connected layer.

In examples above, the feature length produced by positional encoding is 128. However, the positional embedding feature length may be different or variable in other examples, including feature lengths lower or higher than 128.

The examples above were described with relationship to the PCGCv2 AI-based point cloud coding technique as a baseline. However, the positional encoding layer described above can be employed with any point cloud compression method. Also, the techniques described above are with relation to an intra-based compression method. The positional encoding techniques of this disclosure have been shown to improve results in inter-based compression methods, including uni-prediction and bi-prediction.

As described above, the location or position of the positional encoding layer within the network/model can change, e.g., based on performance results for a specific application.

The examples above are directed to a point cloud encoder and point cloud decoder performing point cloud geometry compression. However, the techniques of this disclosure are not limited to geometry compression, but may also be used for point cloud attribute compression or for joint point cloud geometry and attribute compression methods. For example, a point cloud encoder may be configured to encode attributes of the frame of point cloud data using the deep learning network. The deep learning network includes one or more layers configured to generate first features for the attributes, and the deep learning network further includes at least one positional encoding layer configured to generate second features from the attributes and combine the first features with the second features to generate higher-dimensional features. A point cloud decoder may perform the reciprocal process for attribute decoding.

Additionally, point cloud positional encoding/embedding is not limited to point cloud compression tasks but can also be employed for any number of point cloud vision related tasks, including classification, segmentation, etc.

In the examples above, each of the positional encoding layers that use learned positional encoding may be separately trained, and thus may have separately determined, and perhaps unique weights for each of the 1×1×1 convolutions. That is, an encoder network or a decoder network may include a plurality of positional encoding layers, where each of the positional encoding layers is configured to use different sets of weights.

In other examples, the positional encoding layers can share the same weights. With reference to FIG. 7 and FIG. 8, rather than using eight unique positional encoding layers, all with their own weights, an encoder network and a decoder network may each use a single positional encoding layer with the same set of weights, and may reuse such a layer multiple times. This is called weight sharing and decreases the number of parameters in the network and could produce better results.

The positional encoding techniques of this disclosure are not limited to the use of three-dimensional coordinates as the input. That is, an encoder network or a decoder network does not have to be configured to only use three-dimensional coordinates as the input to learn the high dimensional positional feature embedding. Examples could include:
1) For multi-frame dynamic point clouds where an inter-compression scheme is employed, the input to the positional encoding layer could be four dimensional (x,y,z,t), which would contain the three-dimensional spatial coordinates and the fourth dimensional time/sequential information (t). 4D positional encoding may be important for dynamic point cloud compression, but could also be employed to static point clouds;
2) Rather than using only the three-dimensional coordinates, an encoder network or decoder network may use higher dimensional positional information/feature that can be input to a positional encoding layer to obtain another positional feature embedding.

In other examples, rather than using a single type of positional encoding, an encoder network or decoder network may use multiple types of positional encoding. The types of positional encoding layers in an encoder network or decoder network may be selectively activated or deactivated based on a specific type of use case/application and/or based on a specific type of point clouds. As such, an encoder network or decoder network may include a plurality of positional encoding layers, wherein the plurality of positional encoding layers include at least two types of positional encoding.

In general, the positional encoding layers themselves do not generally use any additional overhead in terms of sending extra signals (e.g., syntax elements or metadata) in the bitstream. A positional encoding layer employs the coordinates/position at that tensor to generate higher-dimensional features.

The computational complexity of a positional encoding layer depends on the type of positional encoding employed. For learned positional encoding, the computational complexity is based on the number of layers, number of parameters, and the number of multiplications in the neural network layer. A positional encoding layer implemented with a single convolutional layer of kernel size 1×1×1 is very small. Testing has shown that the use a 1×1×1 kernel in a positional encoding layer did not substantially alter encoding/decoding times.

For the network framework shown FIG. 9, point cloud encoder 910 is configured to signal the geometry bitstream, the feature bitstream, and a small amount of signals for arithmetic encoding. Because the framework of FIG. 9 encodes the coordinates and features separately, there is a possibility of losing the association between the coordinates and features. For this reason, the tensor (containing coordinates and features) may be sorted after processing by point cloud encoder 910 and before processing by point cloud decoder 960 with respect to the coordinates.

In some examples, it may be desirable to design encoder network 700 and decoder network 800 with flexibility in the positional encoding layer. In such an example, point cloud encoder 910 may configured to signal one or more syntax elements to point cloud decoder 960 to indicate manner in which the positional encoding is to be utilized. The syntax elements may indicate one or more of the following parameters:
a first syntax element indicating whether positional encoding is enabled or not;
a second syntax element indicating type of positional encoding being employed (e.g., learned positional encoding, sine and cosine positional encoding, etc.);
a third syntax element indicating a feature size of the positional encoding layer (e.g., a number of channels the positional encoding is learning based);
a fourth syntax element indicating that the location of the positional encoding layer is variable, as well as a position of the positional encoding layers within the network;
a fifth syntax element indicating an input type for positional encoding layer to generate the positional embedding features (e.g., coordinates, coordinates and frame no., higher dimensional features, etc.).

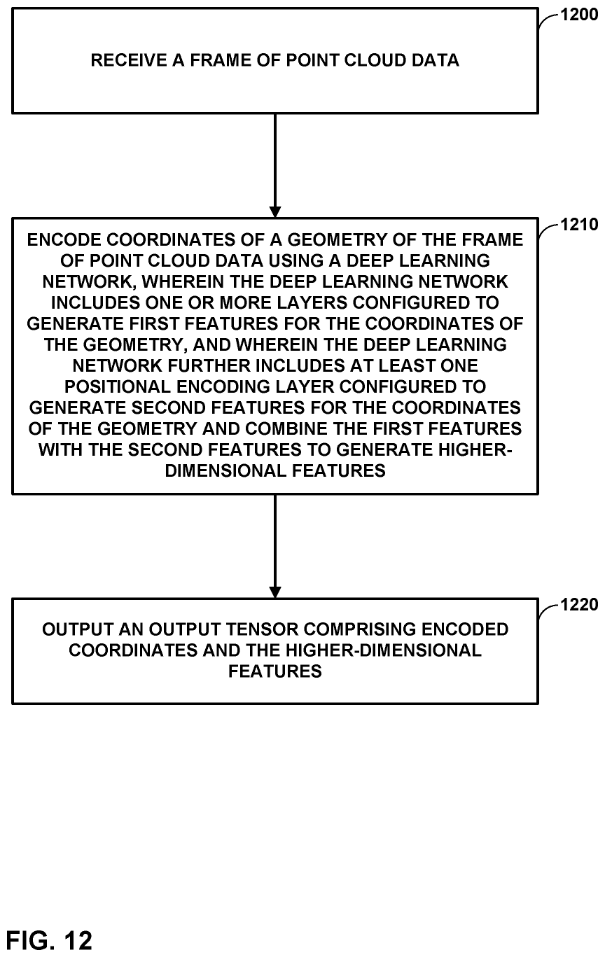

FIG. 12 is a flowchart showing an example encoding technique of the disclosure. The techniques of FIG. 12 may be performed by any AI-based point cloud encoder of the disclosure, including point cloud encoder 200 (FIGS. 1 and 2) and point cloud encoder 910 (FIG. 9). Encoder network 700 (FIG. 7) shows one example of a deep learning network that be used in conjunction with the techniques of this disclosure.

In one example of the disclosure, point cloud encoder 910 may be configured to receive a frame of point cloud data (1200), and encode coordinates of a geometry of the frame of point cloud data using a deep learning network (1210). The deep learning network, where encoder network 700 (FIG. 7) is just one example, includes one or more layers configured to generate first features for the coordinates of the geometry. The deep learning network further includes at least one positional encoding layer configured to generate second features for the coordinates of the geometry and combine the first features with the second features to generate higher-dimensional features. To combine the first features with the second features to generate higher-dimensional features, the positional encoding layer may be configured to concatenate the first features with the second features. In one example, the first features have a feature size of 64 and the higher-dimensional features have a feature size of 192. Point cloud encoder 910 is further configured to output an output tensor comprising encoded coordinates and the higher-dimensional features (1220).

In one example, the deep learning network includes one or more layers configured to downscale the coordinates of the geometry to generate downscaled coordinates, and wherein the output tensor comprises the downscaled coordinates and the higher-dimensional features. In a further example, the at least one position encoding layer of the deep learning network includes a first positional encoding layer that operates on an input of the deep learning network and a second positional encoding layer that operates on the downscaled coordinates.

In another example, the one or more layers of the deep learning network includes three layers configured to progressively downscale the coordinates of the geometry to generate first downscaled coordinates, second downscaled coordinates, and third downscaled coordinates that are three-times downscaled. In this example, the output tensor comprises the third downscaled coordinates and the higher-dimensional features. Further in this example, the at least one position encoding layer of the deep learning network includes a first positional encoding layer that operates on an input of the deep learning network, a second positional encoding layer that operates on the first downscaled coordinates, a third positional encoding layer that operates on the second downscaled coordinates, and a fourth positional encoding layer that operates on the third downscaled coordinates. In one example, at least one of the second positional encoding layer, the third positional encoding layer, or the fourth positional encoding layer is positioned between a layer configured to downscale the coordinates of the geometry and an inception-residual block.

In some examples, the at least one positional encoding layer comprises a learned positional encoding layer. The learned positional encoding layer may configured as a convolutional layer, a fully connected layer, or a multilayer perceptron.

In some examples, the deep learning network includes a plurality of positional encoding layers, and wherein each of the positional encoding layers is configured to use different sets of weights. In other examples, the deep learning network includes a plurality of positional encoding layers, and wherein each of the positional encoding layers is configured to use a same set of weights.

In still other examples, the at least one positional encoding layer comprises one of a sine and cosine positional encoding layer, a linear positional encoding layer, a radial basis function positional encoding layer, a Fermi-Dirac positional encoding layer, a hybrid positional encoding layer, a relative positional encoding layer, or an image grid positional encoding layer. The deep learning network may include a plurality of positional encoding layers, and the plurality of positional encoding layers may include at least two types of positional encoding.

Point cloud encoder 910 may be further configured to encode attributes of the frame of point cloud data using the deep learning network. In this example, the deep learning network includes one or more layers configured to generate third features for the attributes, and the deep learning network further includes at least one positional encoding layer configured to generate fourth features from the attributes and combine the third features with the fourth features to generate second higher-dimensional features.

Point cloud encoder 910 may be further configured to encode any combination of one or more syntax elements, the one or more syntax elements including: a first syntax element indicating whether positional encoding is enabled, a second syntax element indicating a type of positional encoding for the at least one positional encoding layer, a third syntax element indicating a feature size for the at least one positional encoding layer, a fourth syntax element indicating a location of the at least one positional encoding layer, and/or a fifth syntax element indicating an input type for the at least one positional encoding layer.

Point cloud encoder 910 may be further configured to perform octree encoding on the coordinates of the output tensor to generate the encoded coordinates, quantize the higher-dimensional features to generate quantized higher-dimensional features, arithmetically encode the quantized higher-dimensional features of the output tensor using an entropy model to generate encoded higher-dimensional features, and output the encoded coordinates and the encoded higher-dimensional features in an encoded bitstream.

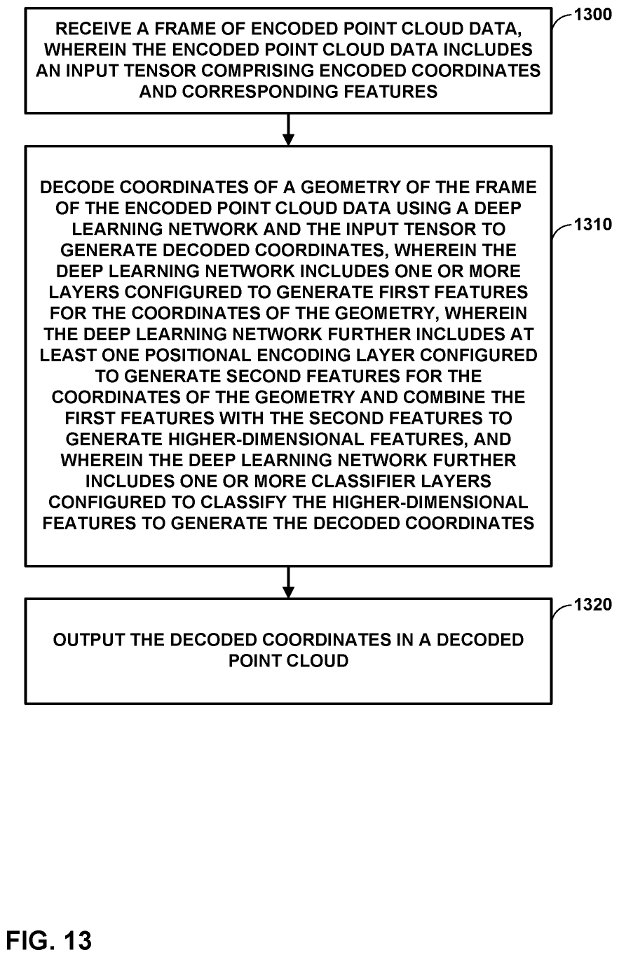

FIG. 13 is a flowchart showing an example decoding technique of the disclosure. The techniques of FIG. 13 may be performed by any AI-based point cloud decoder of the disclosure, including point cloud decoder 300 (FIGS. 1 and 3) and point cloud decoder 960 (FIG. 9). Decoder network 800 (FIG. 8) shows one example of a deep learning network that be used in conjunction with the techniques of this disclosure.

In one example, point cloud decoder 960 may be configured to receive a frame of the encoded point cloud data, wherein the encoded point cloud data includes an input tensor comprising encoded coordinates and corresponding features (1300). Point cloud decoder 960 may be further configured to decode coordinates of a geometry of the frame of the encoded point cloud data using a deep learning network and the input tensor to generate decoded coordinates (1310).

The deep learning network, where decoder network 800 (FIG. 8) is just one example, may include one or more layers configured to generate first features for the coordinates of the geometry. The deep learning network further includes at least one positional encoding layer configured to generate second features for the coordinates of the geometry and combine the first features with the second features to generate higher-dimensional features. The deep learning network further includes one or more classifier layers configured to classify the higher-dimensional features to generate the decoded coordinates. To combine the first features with the second features to generate higher-dimensional features, the positional encoding layer may be configured to concatenate the first features with the second features. In one example, the first features have a feature size of 64 and the higher-dimensional features have a feature size of 192. Point cloud decoder 960 may be further configured to output the decoded coordinates in a decoded point cloud (1320).

In one example, the coordinates of the input tensor comprise downscaled coordinates, and the deep learning network includes one or more layers configured to upscale the downscaled coordinates to generate upscaled coordinates.

In one example, the at least one position encoding layer of the deep learning network includes a first positional encoding layer that operates on an input of the deep learning network and a second positional encoding layer that operates on the upscaled coordinates.

In another example, the one or more layers of the deep learning network includes three layers configured to progressively upscale the downscaled coordinates to generate first upscaled coordinates, second upscaled coordinates, and third upscaled coordinates. In this example, the at least one position encoding layer of the deep learning network includes a first positional encoding layer that operates on an input of the deep learning network, a second positional encoding layer that operates on the first upscaled coordinates, a third positional encoding layer that operates on the second upscaled coordinates, and a fourth positional encoding layer that operates on the third upscaled coordinates. The at least one of the second positional encoding layer, the third positional encoding layer, or the fourth positional encoding layer may be positioned between a layer configured to upscaled the coordinates and an inception-residual block.

In some examples, the at least one positional encoding layer comprises a learned positional encoding layer. The learned positional encoding layer may configured as a convolutional layer, a fully connected layer, or a multilayer perceptron.

In some examples, the deep learning network includes a plurality of positional encoding layers, and wherein each of the positional encoding layers is configured to use different sets of weights. In other examples, the deep learning network includes a plurality of positional encoding layers, and wherein each of the positional encoding layers is configured to use a same set of weights.

In still other examples, the at least one positional encoding layer comprises one of a sine and cosine positional encoding layer, a linear positional encoding layer, a radial basis function positional encoding layer, a Fermi-Dirac positional encoding layer, a hybrid positional encoding layer, a relative positional encoding layer, or an image grid positional encoding layer. The deep learning network may include a plurality of positional encoding layers, and the plurality of positional encoding layers may include at least two types of positional encoding.

In some examples, point cloud decoder 960 may be further configured to decode attributes of the frame of the encoded point cloud data using the deep learning network to generate decoded attributes. In this example, the deep learning network includes one or more layers configured to generate third features for the attributes. The deep learning network further includes at least one positional encoding layer configured to generate fourth features from the attributes and combine the third features with the fourth features to generate second higher-dimensional features. The deep learning network further includes one or more layers configured to classify the higher-dimensional features to generate the decoded attributes.

In another example, point cloud decoder 960 may be further configured to decode one or more syntax elements, the one or more syntax elements including: a first syntax element indicating whether positional encoding is enabled, a second syntax element indicating a type of positional encoding for the at least one positional encoding layer, a third syntax element indicating a feature size for the at least one positional encoding layer, a fourth syntax element indicating a location of the at least one positional encoding layer, and/or a fifth syntax element indicating an input type for the at least one positional encoding layer.

Point cloud decoder 960 may be further configured to perform octree decoding on the encoded coordinates in an encoded bitstream to recover the encoded coordinates in the input tensor, and arithmetically decode encoded features in the encoded bitstream to recover the corresponding features in the input tensor.

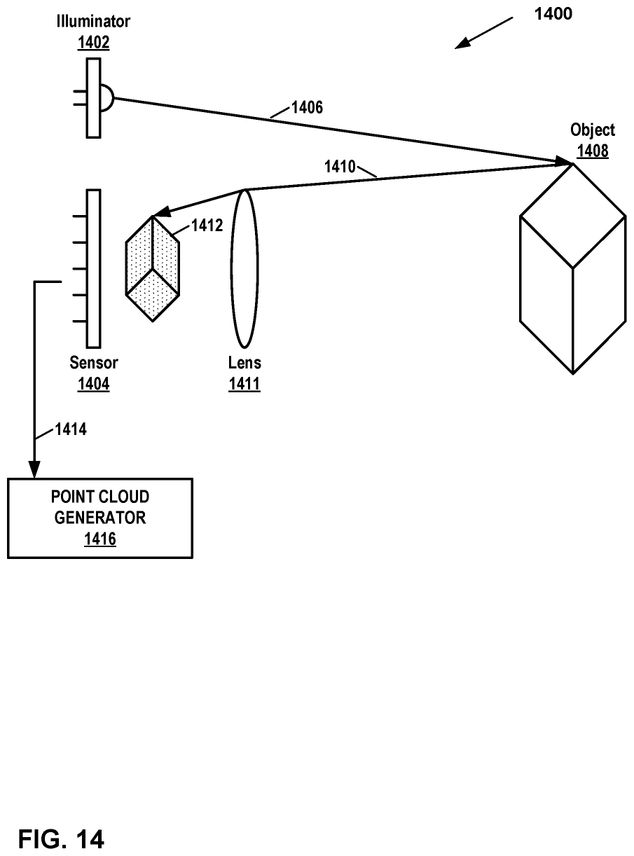

FIG. 14 is a conceptual diagram illustrating an example range-finding system 1400 that may be used with one or more techniques of this disclosure for AI-based point cloud encoding using positional encoding. In the example of FIG. 14, range-finding system 1400 includes an illuminator 1402 and a sensor 1404. Illuminator 1402 may emit light 1406. In some examples, illuminator 1402 may emit light 1406 as one or more laser beams. Light 1406 may be in one or more wavelengths, such as an infrared wavelength or a visible light wavelength. In other examples, light 1406 is not coherent, laser light. When light 1406 encounters an object, such as object 1408, light 1406 creates returning light 1410. Returning light 1410 may include backscattered and/or reflected light. Returning light 1410 may pass through a lens 1411 that directs returning light 1410 to create an image 1412 of object 1408 on sensor 1404. Sensor 1404 generates signals 1414 based on image 1412. Image 1412 may comprise a set of points (e.g., as represented by dots in image 1412 of FIG. 14).

In some examples, illuminator 1402 and sensor 1404 may be mounted on a spinning structure so that illuminator 1402 and sensor 1404 capture a 360-degree view of an environment (e.g., a spinning LIDAR sensor). In other examples, range-finding system 1400 may include one or more optical components (e.g., mirrors, collimators, diffraction gratings, etc.) that enable illuminator 1402 and sensor 1404 to detect ranges of objects within a specific range (e.g., up to 360-degrees). Although the example of FIG. 14 only shows a single illuminator 1402 and sensor 1404, range-finding system 1400 may include multiple sets of illuminators and sensors.

In some examples, illuminator 1402 generates a structured light pattern. In such examples, range-finding system 1400 may include multiple sensors 1404 upon which respective images of the structured light pattern are formed. Range-finding system 1400 may use disparities between the images of the structured light pattern to determine a distance to an object 1408 from which the structured light pattern backscatters. Structured light-based range-finding systems may have a high level of accuracy (e.g., accuracy in the sub-millimeter range), when object 1408 is relatively close to sensor 1404 (e.g., 0.2 meters to 2 meters). This high level of accuracy may be useful in facial recognition applications, such as unlocking mobile devices (e.g., mobile phones, tablet computers, etc.) and for security applications.

In some examples, range-finding system 1400 is a time of flight (ToF)-based system. In some examples where range-finding system 1400 is a ToF-based system, illuminator 1402 generates pulses of light. In other words, illuminator 1402 may modulate the amplitude of emitted light 1406. In such examples, sensor 1404 detects returning light 1410 from the pulses of light 1406 generated by illuminator 1402. Range-finding system 1400 may then determine a distance to object 1408 from which light 1406 backscatters based on a delay between when light 1406 was emitted and detected and the known speed of light in air). In some examples, rather than (or in addition to) modulating the amplitude of the emitted light 1406, illuminator 1402 may modulate the phase of the emitted light 1406. In such examples, sensor 1404 may detect the phase of returning light 1410 from object 1408 and determine distances to points on object 1408 using the speed of light and based on time differences between when illuminator 1402 generated light 1406 at a specific phase and when sensor 1404 detected returning light 1410 at the specific phase.

In other examples, a point cloud may be generated without using illuminator 1402. For instance, in some examples, sensors 1404 of range-finding system 1400 may include two or more optical cameras. In such examples, range-finding system 1400 may use the optical cameras to capture stereo images of the environment, including object 1408. Range-finding system 1400 may include a point cloud generator 1416 that may calculate the disparities between locations in the stereo images. Range-finding system 1400 may then use the disparities to determine distances to the locations shown in the stereo images. From these distances, point cloud generator 1416 may generate a point cloud.

Sensors 1404 may also detect other attributes of object 1408, such as color and reflectance information. In the example of FIG. 14, a point cloud generator 1416 may generate a point cloud based on signals 1414 generated by sensor 1404. Range-finding system 1400 and/or point cloud generator 1416 may form part of data source 104 (FIG. 1). Hence, a point cloud generated by range-finding system 1400 may be encoded and/or decoded according to any of the techniques of this disclosure for point cloud compression using positional encoding. Inter prediction and residual prediction, as described in this disclosure may reduce the size of the encoded data.

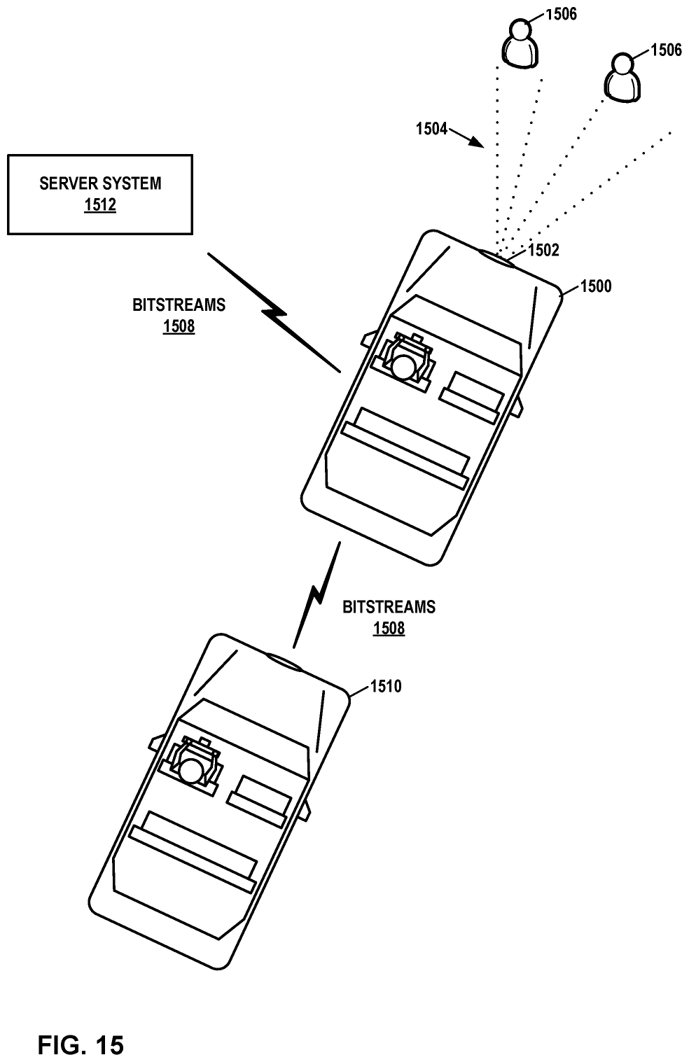

FIG. 15 is a conceptual diagram illustrating an example vehicle-based scenario in which one or more techniques of this disclosure for point cloud compression using positional encoding may be used. In the example of FIG. 15, a vehicle 1500 includes a range-finding system 1502. Range-finding system 1502 may be implemented in the manner discussed with respect to FIG. 14. Although not shown in the example of FIG. 15, vehicle 1500 may also include a data source, such as data source 104 (FIG. 1), and a point cloud encoder, such as point cloud encoder 200 (FIG. 1). In the example of FIG. 15, range-finding system 1502 emits laser beams 1504 that reflect off pedestrians 1506 or other objects in a roadway. The data source of vehicle 1500 may generate a point cloud based on signals generated by range-finding system 1502. The point cloud encoder of vehicle 1500 may encode the point cloud to generate bitstreams 1508, such as geometry bitstream (FIG. 2) and attribute bitstream (FIG. 2). Inter prediction and residual prediction may reduce the size of the geometry bitstream. Bitstreams 1508 may include many fewer bits than the unencoded point cloud obtained by the point cloud encoder.

An output interface of vehicle 1500 (e.g., output interface 108 (FIG. 1) may transmit bitstreams 1508 to one or more other devices. Bitstreams 1508 may include many fewer bits than the unencoded point cloud obtained by the point cloud encoder. Thus, vehicle 1500 may be able to transmit bitstreams 1508 to other devices more quickly than the unencoded point cloud data. Additionally, bitstreams 1508 may require less data storage capacity on a device.

In the example of FIG. 15, vehicle 1500 may transmit bitstreams 1508 to another vehicle 1510. Vehicle 1510 may include a point cloud decoder, such as point cloud decoder 300 (FIG. 1). The point cloud decoder of vehicle 1510 may decode bitstreams 1508 to reconstruct the point cloud. Vehicle 1510 may use the reconstructed point cloud for various purposes. For instance, vehicle 1510 may determine based on the reconstructed point cloud that pedestrians 1506 are in the roadway ahead of vehicle 1500 and therefore start slowing down, e.g., even before a driver of vehicle 1510 realizes that pedestrians 1506 are in the roadway. Thus, in some examples, vehicle 1510 may perform an autonomous navigation operation based on the reconstructed point cloud.

Additionally or alternatively, vehicle 1500 may transmit bitstreams 1508 to a server system 1512. Server system 1512 may use bitstreams 1508 for various purposes. For example, server system 1512 may store bitstreams 1508 for subsequent reconstruction of the point clouds. In this example, server system 1512 may use the point clouds along with other data (e.g., vehicle telemetry data generated by vehicle 1500) to train an autonomous driving system. In other example, server system 1512 may store bitstreams 1508 for subsequent reconstruction for forensic crash investigations.

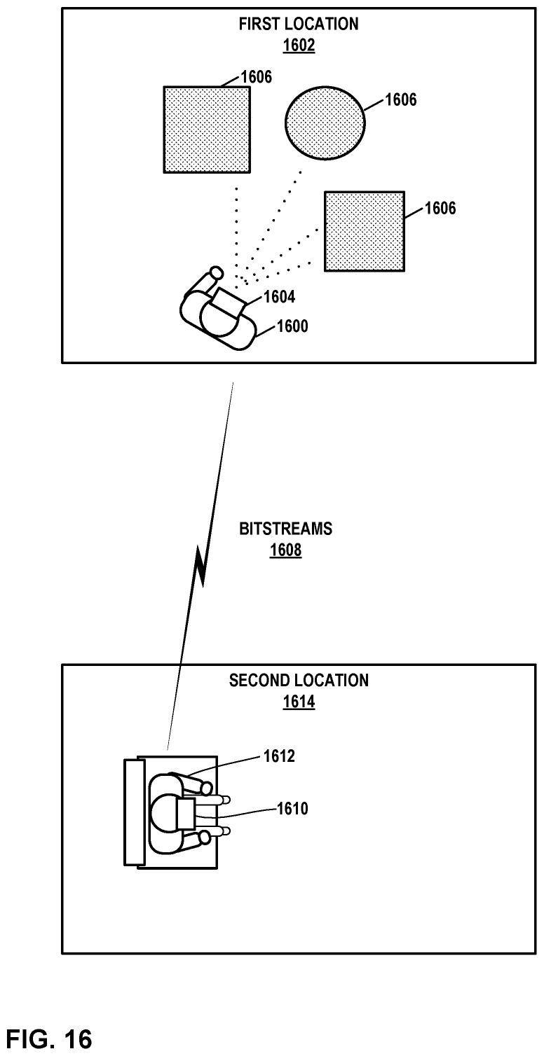

FIG. 16 is a conceptual diagram illustrating an example extended reality system in which one or more techniques of this disclosure for point cloud compression using positional encoding may be used. Extended reality (XR) is a term used to cover a range of technologies that includes augmented reality (AR), mixed reality (MR), and virtual reality (VR). In the example of FIG. 16, a user 1600 is located in a first location 1602. User 1600 wears an XR headset 1604. As an alternative to XR headset 1604, user 1600 may use a mobile device (e.g., mobile phone, tablet computer, etc.). XR headset 1604 includes a depth detection sensor, such as a range-finding system, that detects positions of points on objects 1606 at location 1602. A data source of XR headset 1604 may use the signals generated by the depth detection sensor to generate a point cloud representation of objects 1606 at location 1602. XR headset 1604 may include a point cloud encoder (e.g., point cloud encoder 200 of FIG. 1) that is configured to encode the point cloud to generate bitstreams 1608. Inter prediction and residual prediction, as described in this disclosure may reduce the size of bitstream 1608.

XR headset 1604 may transmit bitstreams 1608 (e.g., via a network such as the Internet) to an XR headset 1610 worn by a user 1612 at a second location 1614. XR headset 1610 may decode bitstreams 1608 to reconstruct the point cloud. XR headset 1610 may use the point cloud to generate an XR visualization (e.g., an AR, MR, VR visualization) representing objects 1606 at location 1602. Thus, in some examples, such as when XR headset 1610 generates an VR visualization, user 1612 may have a 3D immersive experience of location 1602. In some examples, XR headset 1610 may determine a position of a virtual object based on the reconstructed point cloud. For instance, XR headset 1610 may determine, based on the reconstructed point cloud, that an environment (e.g., location 1602) includes a flat surface and then determine that a virtual object (e.g., a cartoon character) is to be positioned on the flat surface. XR headset 1610 may generate an XR visualization in which the virtual object is at the determined position. For instance, XR headset 1610 may show the cartoon character sitting on the flat surface.

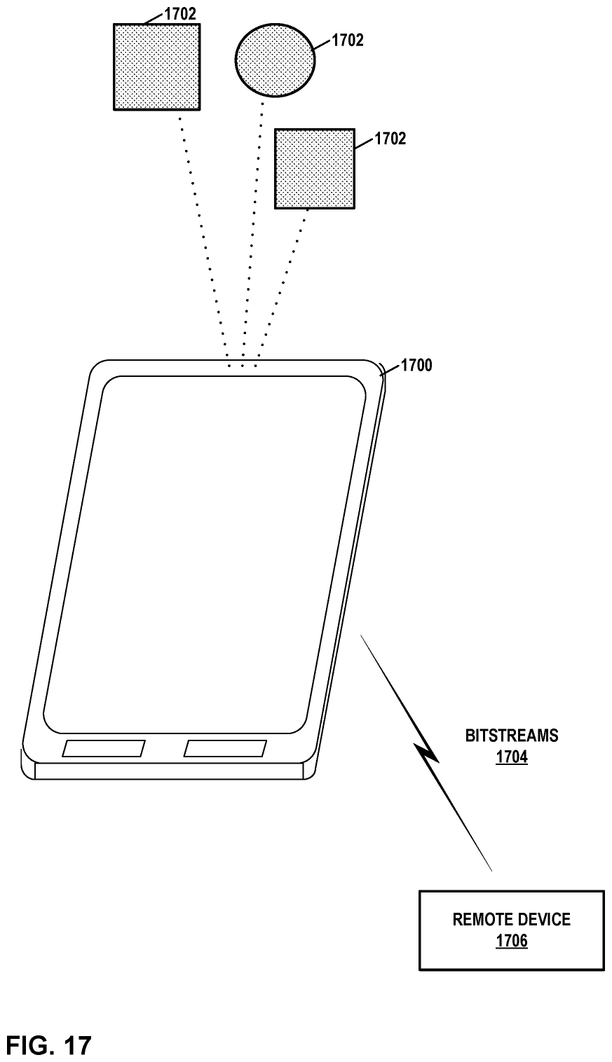

FIG. 17 is a conceptual diagram illustrating an example mobile device system in which one or more techniques of this disclosure for point cloud compression using positional encoding may be used. In the example of FIG. 17, a mobile device 1700 (e.g., a wireless communication device), such as a mobile phone or tablet computer, includes a range-finding system, such as a LIDAR system, that detects positions of points on objects 1702 in an environment of mobile device 1700. A data source of mobile device 1700 may use the signals generated by the depth detection sensor to generate a point cloud representation of objects 1702. Mobile device 1700 may include a point cloud encoder (e.g., point cloud encoder 170 of FIG. 1) that is configured to encode the point cloud to generate bitstreams 1704. In the example of FIG. 17, mobile device 1700 may transmit bitstreams to a remote device 1706, such as a server system or other mobile device. Inter prediction and residual prediction, as described in this disclosure may reduce the size of bitstreams 1704. Remote device 1706 may decode bitstreams 1704 to reconstruct the point cloud. Remote device 1706 may use the point cloud for various purposes. For example, remote device 1706 may use the point cloud to generate a map of environment of mobile device 1700. For instance, remote device 1706 may generate a map of an interior of a building based on the reconstructed point cloud. In another example, remote device 1706 may generate imagery (e.g., computer graphics) based on the point cloud. For instance, remote device 1706 may use points of the point cloud as vertices of polygons and use color attributes of the points as the basis for shading the polygons. In some examples, remote device 1706 may use the reconstructed point cloud for facial recognition or other security applications.

The following numbered clauses illustrate one or more aspects of the devices and techniques described in this disclosure.
Clause 1. An apparatus configured to encode a point cloud, the apparatus comprising: one or more memories configured to store point cloud data; and processing circuitry in communication with the one or more memories, the processing circuitry configured to: receive a frame of point cloud data; encode coordinates of a geometry of the frame of point cloud data using a deep learning network, wherein the deep learning network includes one or more layers configured to generate first features for the coordinates of the geometry, and wherein the deep learning network further includes at least one positional encoding layer configured to generate second features for the coordinates of the geometry and combine the first features with the second features to generate higher-dimensional features; and output an output tensor comprising encoded coordinates and the higher-dimensional features.
Clause 2. The apparatus of Clause 1, wherein the deep learning network includes one or more layers configured to downscale the coordinates of the geometry to generate downscaled coordinates, and wherein the output tensor comprises the downscaled coordinates and the higher-dimensional features.
Clause 3. The apparatus of Clause 2, wherein the at least one position encoding layer of the deep learning network includes a first positional encoding layer that operates on an input of the deep learning network and a second positional encoding layer that operates on the downscaled coordinates.
Clause 4. The apparatus of any of Clauses 1-3, wherein the one or more layers of the deep learning network includes three layers configured to progressively downscale the coordinates of the geometry to generate first downscaled coordinates, second downscaled coordinates, and third downscaled coordinates, and wherein the output tensor comprises the third downscaled coordinates that are three-times downscaled and the higher-dimensional features.
Clause 5. The apparatus of Clause 4, wherein the at least one position encoding layer of the deep learning network includes a first positional encoding layer that operates on an input of the deep learning network, a second positional encoding layer that operates on the first downscaled coordinates, a third positional encoding layer that operates on the second downscaled coordinates, and a fourth positional encoding layer that operates on the third downscaled coordinates.
Clause 6. The apparatus of Clause 5, wherein at least one of the second positional encoding layer, the third positional encoding layer, or the fourth positional encoding layer is positioned between a layer configured to downscale the coordinates of the geometry and an inception-residual block.
Clause 7. The apparatus of any of Clauses 1-6, wherein the at least one positional encoding layer comprises a learned positional encoding layer.
Clause 8. The apparatus of Clause 7, wherein the learned positional encoding layer is configured as a convolutional layer, a fully connected layer, or a multilayer perceptron.
Clause 9. The apparatus of any of Clauses 1-8, wherein the deep learning network includes a plurality of positional encoding layers, and wherein each of the positional encoding layers is configured to use different sets of weights.
Clause 10. The apparatus of any of Clauses 1-8, wherein the deep learning network includes a plurality of positional encoding layers, and wherein each of the positional encoding layers is configured to use a same set of weights.
Clause 11. The apparatus of any of Clauses 1-10, wherein the at least one positional encoding layer comprises one of a sine and cosine positional encoding layer, a linear positional encoding layer, a radial basis function positional encoding layer, a Fermi-Dirac positional encoding layer, a hybrid positional encoding layer, a relative positional encoding layer, or an image grid positional encoding layer.
Clause 12. The apparatus of any of Clauses 1-11, wherein the deep learning network includes a plurality of positional encoding layers, and wherein the plurality of positional encoding layers include at least two types of positional encoding.
Clause 13. The apparatus of any of Clauses 1-12, wherein to combine the first features with the second features to generate higher-dimensional features, the positional encoding layer is configured to concatenate the first features with the second features.
Clause 14. The apparatus of Clause 13, wherein the first features have a feature size of 64 and wherein the higher-dimensional features have a feature size of 192.
Clause 15. The apparatus of any of Clauses 1-14, wherein the processing circuitry is further configured to: encode attributes of the frame of point cloud data using the deep learning network, wherein the deep learning network includes one or more layers configured to generate third features for the attributes, and wherein the deep learning network further includes at least one positional encoding layer configured to generate fourth features from the attributes and combine the third features with the fourth features to generate second higher-dimensional features.
Clause 16. The apparatus of any of Clauses 1-15, wherein the processing circuitry is further configured to: encode one or more syntax elements, the one or more syntax elements including: a first syntax element indicating whether positional encoding is enabled, a second syntax element indicating a type of positional encoding for the at least one positional encoding layer, a third syntax element indicating a feature size for the at least one positional encoding layer, a fourth syntax element indicating a location of the at least one positional encoding layer, or a fifth syntax element indicating an input type for the at least one positional encoding layer.
Clause 17. The apparatus of any of Clauses 1-16, wherein the processing circuitry is further configured to: perform octree encoding on the coordinates of the output tensor to generate the encoded coordinates; quantize the higher-dimensional features to generate quantized higher-dimensional features; arithmetically encode the quantized higher-dimensional features of the output tensor using an entropy model to generate encoded higher-dimensional features; and output the encoded coordinates and the encoded higher-dimensional features in an encoded bitstream.
Clause 18. The apparatus of any of Clauses 1-17, further comprising: a sensor configured to capture the frame of point cloud data.
Clause 19. A method of encoding a point cloud, the method comprising: receiving a frame of point cloud data; encoding coordinates of a geometry of the frame of point cloud data using a deep learning network, wherein the deep learning network includes one or more layers configured to generate first features for the coordinates of the geometry, and wherein the deep learning network further includes at least one positional encoding layer configured to generate second features for the coordinates of the geometry and combine the first features with the second features to generate higher-dimensional features; and outputting an output tensor comprising encoded coordinates and the higher-dimensional features.
Clause 20. The method of Clause 19, wherein the deep learning network includes one or more layers configured to downscale the coordinates of the geometry to generate downscaled coordinates, and wherein the output tensor comprises the downscaled coordinates and the higher-dimensional features.
Clause 21. The method of Clause 20, wherein the at least one position encoding layer of the deep learning network includes a first positional encoding layer that operates on an input of the deep learning network and a second positional encoding layer that operates on the downscaled coordinates.
Clause 22. The method of any of Clauses 19-21, wherein the one or more layers of the deep learning network includes three layers configured to progressively downscale the coordinates of the geometry to generate first downscaled coordinates, second downscaled coordinates, and third downscaled coordinates, and wherein the output tensor comprises the third downscaled coordinates that are three-times downscaled and the higher-dimensional features.
Clause 23. The method of Clause 22, wherein the at least one position encoding layer of the deep learning network includes a first positional encoding layer that operates on an input of the deep learning network, a second positional encoding layer that operates on the first downscaled coordinates, a third positional encoding layer that operates on the second downscaled coordinates, and a fourth positional encoding layer that operates on the third downscaled coordinates.
Clause 24. The method of Clause 23, wherein at least one of the second positional encoding layer, the third positional encoding layer, or the fourth positional encoding layer is positioned between a layer configured to downscale the coordinates of the geometry and an inception-residual block.
Clause 25. The method of any of Clauses 19-24, wherein the at least one positional encoding layer comprises a learned positional encoding layer.
Clause 26. The method of Clause 25, wherein the learned positional encoding layer is configured as a convolutional layer, a fully connected layer, or a multilayer perceptron.
Clause 27. The method of any of Clauses 19-26, wherein the deep learning network includes a plurality of positional encoding layers, and wherein each of the positional encoding layers is configured to use different sets of weights.
Clause 28. The method of any of Clauses 19-26, wherein the deep learning network includes a plurality of positional encoding layers, and wherein each of the positional encoding layers is configured to use a same set of weights.
Clause 29. The method of any of Clauses 19-28, wherein the at least one positional encoding layer comprises one of a sine and cosine positional encoding layer, a linear positional encoding layer, a radial basis function positional encoding layer, a Fermi-Dirac positional encoding layer, a hybrid positional encoding layer, a relative positional encoding layer, or an image grid positional encoding layer.
Clause 30. The method of any of Clauses 19-29, wherein the deep learning network includes a plurality of positional encoding layers, and wherein the plurality of positional encoding layers include at least two types of positional encoding.
Clause 31. The method of any of Clauses 19-30, wherein to combine the first features with the second features to generate higher-dimensional features, the positional encoding layer is configured to concatenate the first features with the second features.
Clause 32. The method of Clause 31, wherein the first features have a feature size of 64 and wherein the higher-dimensional features have a feature size of 192.
Clause 33. The method of any of Clauses 19-32, further comprising: encoding attributes of the frame of point cloud data using the deep learning network, wherein the deep learning network includes one or more layers configured to generate third features for the attributes, and wherein the deep learning network further includes at least one positional encoding layer configured to generate fourth features from the attributes and combine the third features with the fourth features to generate second higher-dimensional features.
Clause 34. The method of any of Clauses 19-33, further comprising: encoding one or more syntax elements, the one or more syntax elements including: a first syntax element indicating whether positional encoding is enabled, a second syntax element indicating a type of positional encoding for the at least one positional encoding layer, a third syntax element indicating a feature size for the at least one positional encoding layer, a fourth syntax element indicating a location of the at least one positional encoding layer, or a fifth syntax element indicating an input type for the at least one positional encoding layer.
Clause 35. The method of any of Clauses 19-34, further comprising: performing octree encoding on the coordinates of the output tensor to generate the encoded coordinates; quantizing the higher-dimensional features to generate quantized higher-dimensional features; arithmetically encoding the quantized higher-dimensional features of the output tensor using an entropy model to generate encoded higher-dimensional features; and outputting the encoded coordinates and the encoded higher-dimensional features in an encoded bitstream.
Clause 36. The method of any of Clauses 19-35, further comprising: capturing the frame of point cloud data using a sensor.
Clause 37. An apparatus configured to decode encoded point cloud data, the apparatus comprising: one or more memories configured to store the encoded point cloud data; and processing circuitry in communication with the one or more memories, the processing circuitry configured to: receive a frame of the encoded point cloud data, wherein the encoded point cloud data includes an input tensor comprising encoded coordinates and corresponding features; decode coordinates of a geometry of the frame of the encoded point cloud data using a deep learning network and the input tensor to generate decoded coordinates, wherein the deep learning network includes one or more layers configured to generate first features for the coordinates of the geometry, wherein the deep learning network further includes at least one positional encoding layer configured to generate second features for the coordinates of the geometry and combine the first features with the second features to generate higher-dimensional features, and wherein the deep learning network further includes one or more classifier layers configured to classify the higher-dimensional features to generate the decoded coordinates; and output the decoded coordinates in a decoded point cloud.
Clause 38. The apparatus of Clause 37, wherein the coordinates of the input tensor comprise downscaled coordinates, and wherein the deep learning network includes one or more layers configured to upscale the downscaled coordinates to generate upscaled coordinates.
Clause 39. The apparatus of Clause 38, wherein the at least one position encoding layer of the deep learning network includes a first positional encoding layer that operates on an input of the deep learning network and a second positional encoding layer that operates on the upscaled coordinates.
Clause 40. The apparatus of any of Clauses 38-39, wherein the one or more layers of the deep learning network includes three layers configured to progressively upscale the downscaled coordinates to generate first upscaled coordinates, second upscaled coordinates, and third upscaled coordinates.
Clause 41. The apparatus of Clause 40, wherein the at least one position encoding layer of the deep learning network includes a first positional encoding layer that operates on an input of the deep learning network, a second positional encoding layer that operates on the first upscaled coordinates, a third positional encoding layer that operates on the second upscaled coordinates, and a fourth positional encoding layer that operates on the third upscaled coordinates.
Clause 42. The apparatus of Clause 41, wherein at least one of the second positional encoding layer, the third positional encoding layer, or the fourth positional encoding layer is positioned between a layer configured to upscaled the coordinates and an inception-residual block.
Clause 43. The apparatus of any of Clauses 37-42, wherein the at least one positional encoding layer comprises a learned positional encoding layer.
Clause 44. The apparatus of Clause 43, wherein the learned positional encoding layer is configured as a convolutional layer, a fully connected layer, or a multilayer perceptron.
Clause 45. The apparatus of any of Clauses 37-44, wherein the deep learning network includes a plurality of positional encoding layers, and wherein each of the positional encoding layers is configured to use different sets of weights.
Clause 46. The apparatus of any of Clauses 37-44, wherein the deep learning network includes a plurality of positional encoding layers, and wherein each of the positional encoding layers is configured to use a same set of weights.
Clause 47. The apparatus of any of Clauses 37-46, wherein the at least one positional encoding layer comprises one of a sine and cosine positional encoding layer, a linear positional encoding layer, a radial basis function positional encoding layer, a Fermi-Dirac positional encoding layer, a hybrid positional encoding layer, a relative positional encoding layer, or an image grid positional encoding layer.
Clause 48. The apparatus of any of Clauses 37-47, wherein the deep learning network includes a plurality of positional encoding layers, and wherein the plurality of positional encoding layers include at least two types of positional encoding.
Clause 49. The apparatus of any of Clauses 37-48, wherein to combine the first features with the second features to generate higher-dimensional features, the positional encoding layer is configured to concatenate the first features with the second features.
Clause 50. The apparatus of Clause 49, wherein the first features have a feature size of 64 and wherein the higher-dimensional features have a feature size of 192.
Clause 51. The apparatus of any of Clauses 37-50, wherein the processing circuitry is further configured to: decode attributes of the frame of the encoded point cloud data using the deep learning network to generate decoded attributes, wherein the deep learning network includes one or more layers configured to generate third features for the attributes, wherein the deep learning network further includes at least one positional encoding layer configured to generate fourth features from the attributes and combine the third features with the fourth features to generate second higher-dimensional features, and wherein the deep learning network further includes one or more layers configured to classify the higher-dimensional features to generate the decoded attributes.
Clause 52. The apparatus of any of Clauses 37-51, wherein the processing circuitry is further configured to: decode one or more syntax elements, the one or more syntax elements including: a first syntax element indicating whether positional encoding is enabled, a second syntax element indicating a type of positional encoding for the at least one positional encoding layer, a third syntax element indicating a feature size for the at least one positional encoding layer, a fourth syntax element indicating a location of the at least one positional encoding layer, or a fifth syntax element indicating an input type for the at least one positional encoding layer.
Clause 53. The apparatus of any of Clauses 37-52, wherein the processing circuitry is further configured to: perform octree decoding on the encoded coordinates in an encoded bitstream to recover the encoded coordinates in the input tensor; and arithmetically decode encoded features in the encoded bitstream to recover the corresponding features in the input tensor.
Clause 54. The apparatus of any of Clauses 37-53, further comprising: a display configured to display the encoded point cloud.
Clause 55. A method of decoding a point cloud, the method comprising: receiving a frame of encoded point cloud data, wherein the encoded point cloud data includes an input tensor comprising encoded coordinates and corresponding features; decoding coordinates of a geometry of the frame of the encoded point cloud data using a deep learning network and the input tensor to generate decoded coordinates, wherein the deep learning network includes one or more layers configured to generate first features for the coordinates of the geometry, wherein the deep learning network further includes at least one positional encoding layer configured to generate second features for the coordinates of the geometry and combine the first features with the second features to generate higher-dimensional features, and wherein the deep learning network further includes one or more classifier layers configured to classify the higher-dimensional features to generate the decoded coordinates; and outputting the decoded coordinates in a decoded point cloud.
Clause 56. The method of Clause 55, wherein the coordinates of the input tensor comprise downscaled coordinates, and wherein the deep learning network includes one or more layers configured to upscale the downscaled coordinates to generate upscaled coordinates.
Clause 57. The method of Clause 56, wherein the at least one position encoding layer of the deep learning network includes a first positional encoding layer that operates on an input of the deep learning network and a second positional encoding layer that operates on the upscaled coordinates.
Clause 58. The method of any of Clauses 56-57, wherein the one or more layers of the deep learning network includes three layers configured to progressively upscale the downscaled coordinates to generate first upscaled coordinates, second upscaled coordinates, and third upscaled coordinates.
Clause 59. The method of Clause 58, wherein the at least one position encoding layer of the deep learning network includes a first positional encoding layer that operates on an input of the deep learning network, a second positional encoding layer that operates on the first upscaled coordinates, a third positional encoding layer that operates on the second upscaled coordinates, and a fourth positional encoding layer that operates on the third upscaled coordinates.
Clause 60. The method of Clause 59, wherein at least one of the second positional encoding layer, the third positional encoding layer, or the fourth positional encoding layer is positioned between a layer configured to upscaled the coordinates and an inception-residual block.
Clause 61. The method of any of Clauses 55-60, wherein the at least one positional encoding layer comprises a learned positional encoding layer.
Clause 62. The method of Clause 61, wherein the learned positional encoding layer is configured as a convolutional layer, a fully connected layer, or a multilayer perceptron.
Clause 63. The method of any of Clauses 55-62, wherein the deep learning network includes a plurality of positional encoding layers, and wherein each of the positional encoding layers is configured to use different sets of weights.
Clause 64. The method of any of Clauses 55-62, wherein the deep learning network includes a plurality of positional encoding layers, and wherein each of the positional encoding layers is configured to use a same set of weights.
Clause 65. The method of any of Clauses 55-64, wherein the at least one positional encoding layer comprises one of a sine and cosine positional encoding layer, a linear positional encoding layer, a radial basis function positional encoding layer, a Fermi-Dirac positional encoding layer, a hybrid positional encoding layer, a relative positional encoding layer, or an image grid positional encoding layer.
Clause 66. The method of any of Clauses 55-65, wherein the deep learning network includes a plurality of positional encoding layers, and wherein the plurality of positional encoding layers include at least two types of positional encoding.
Clause 67. The method of any of Clauses 55-66, wherein to combine the first features with the second features to generate higher-dimensional features, the positional encoding layer is configured to concatenate the first features with the second features.
Clause 68. The method of Clause 67, wherein the first features have a feature size of 64 and wherein the higher-dimensional features have a feature size of 192.
Clause 69. The method of any of Clauses 55-68, further comprising: decoding attributes of the frame of the encoded point cloud data using the deep learning network to generate decoded attributes, wherein the deep learning network includes one or more layers configured to generate third features for the attributes, wherein the deep learning network further includes at least one positional encoding layer configured to generate fourth features from the attributes and combine the third features with the fourth features to generate second higher-dimensional features, and wherein the deep learning network further includes one or more layers configured to classify the higher-dimensional features to generate the decoded attributes.
Clause 70. The method of any of Clauses 55-69, further comprising: decoding one or more syntax elements, the one or more syntax elements including: a first syntax element indicating whether positional encoding is enabled, a second syntax element indicating a type of positional encoding for the at least one positional encoding layer, a third syntax element indicating a feature size for the at least one positional encoding layer, a fourth syntax element indicating a location of the at least one positional encoding layer, or a fifth syntax element indicating an input type for the at least one positional encoding layer.
Clause 71. The method of any of Clauses 55-70, further comprising: performing octree decoding on the encoded coordinates in an encoded bitstream to recover the encoded coordinates in the input tensor; and arithmetically decoding encoded features in the encoded bitstream to recover the corresponding features in the input tensor.
Clause 72. The method of any of Clauses 55-71, further comprising: displaying the encoded point cloud.

Examples in the various aspects of this disclosure may be used individually or in any combination.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus configured to encode a point cloud, the apparatus comprising:
one or more memories configured to store point cloud data; and
processing circuitry in communication with the one or more memories, the processing circuitry configured to:
receive a frame of point cloud data;
encode coordinates of a geometry of the frame of point cloud data using a deep learning network, wherein the deep learning network includes one or more layers configured to generate first features for the coordinates of the geometry, and wherein the deep learning network further includes at least one positional encoding layer configured to generate second features for the coordinates of the geometry and combine the first features with the second features to generate higher-dimensional features; and
output an output tensor comprising encoded coordinates and the higher-dimensional features.

2. The apparatus of claim 1, wherein the deep learning network includes one or more layers configured to downscale the coordinates of the geometry to generate downscaled coordinates, and wherein the output tensor comprises the downscaled coordinates and the higher-dimensional features.

3. The apparatus of claim 2, wherein the at least one position encoding layer of the deep learning network includes a first positional encoding layer that operates on an input of the deep learning network and a second positional encoding layer that operates on the downscaled coordinates.

4. The apparatus of claim 1, wherein the one or more layers of the deep learning network includes three layers configured to progressively downscale the coordinates of the geometry to generate first downscaled coordinates, second downscaled coordinates, and third downscaled coordinates, and wherein the output tensor comprises the third downscaled coordinates that are three-times downscaled and the higher-dimensional features.

5. The apparatus of claim 4, wherein the at least one position encoding layer of the deep learning network includes a first positional encoding layer that operates on an input of the deep learning network, a second positional encoding layer that operates on the first downscaled coordinates, a third positional encoding layer that operates on the second downscaled coordinates, and a fourth positional encoding layer that operates on the third downscaled coordinates.

6. The apparatus of claim 5, wherein at least one of the second positional encoding layer, the third positional encoding layer, or the fourth positional encoding layer is positioned between a layer configured to downscale the coordinates of the geometry and an inception-residual block.

7. The apparatus of claim 1, wherein the at least one positional encoding layer comprises a learned positional encoding layer.

8. The apparatus of claim 7, wherein the learned positional encoding layer is configured as a convolutional layer, a fully connected layer, or a multilayer perceptron.

9. The apparatus of claim 1, wherein the deep learning network includes a plurality of positional encoding layers, and wherein each of the positional encoding layers is configured to use different sets of weights.

10. The apparatus of claim 1, wherein the deep learning network includes a plurality of positional encoding layers, and wherein each of the positional encoding layers is configured to use a same set of weights.

11. The apparatus of claim 1, wherein the at least one positional encoding layer comprises one of a sine and cosine positional encoding layer, a linear positional encoding layer, a radial basis function positional encoding layer, a Fermi-Dirac positional encoding layer, a hybrid positional encoding layer, a relative positional encoding layer, or an image grid positional encoding layer.

12. The apparatus of claim 1, wherein the deep learning network includes a plurality of positional encoding layers, and wherein the plurality of positional encoding layers include at least two types of positional encoding.

13. The apparatus of claim 1, wherein to combine the first features with the second features to generate higher-dimensional features, the positional encoding layer is configured to concatenate the first features with the second features.

14. The apparatus of claim 13, wherein the first features have a feature size of 64 and wherein the higher-dimensional features have a feature size of 192.

15. The apparatus of claim 1, wherein the processing circuitry is further configured to:
encode attributes of the frame of point cloud data using the deep learning network, wherein the deep learning network includes one or more layers configured to generate third features for the attributes, and wherein the deep learning network further includes at least one positional encoding layer configured to generate fourth features from the attributes and combine the third features with the fourth features to generate second higher-dimensional features.

16. The apparatus of claim 1, wherein the processing circuitry is further configured to:
encode one or more syntax elements, the one or more syntax elements including:
a first syntax element indicating whether positional encoding is enabled,
a second syntax element indicating a type of positional encoding for the at least one positional encoding layer,
a third syntax element indicating a feature size for the at least one positional encoding layer,
a fourth syntax element indicating a location of the at least one positional encoding layer, or
a fifth syntax element indicating an input type for the at least one positional encoding layer.

17. The apparatus of claim 1, wherein the processing circuitry is further configured to:
perform octree encoding on the coordinates of the output tensor to generate the encoded coordinates;
quantize the higher-dimensional features to generate quantized higher-dimensional features;
arithmetically encode the quantized higher-dimensional features of the output tensor using an entropy model to generate encoded higher-dimensional features; and
output the encoded coordinates and the encoded higher-dimensional features in an encoded bitstream.

18. The apparatus of claim 1, further comprising:
a sensor configured to capture the frame of point cloud data.

19. A method of encoding a point cloud, the method comprising:
receiving a frame of point cloud data;
encoding coordinates of a geometry of the frame of point cloud data using a deep learning network, wherein the deep learning network includes one or more layers configured to generate first features for the coordinates of the geometry, and wherein the deep learning network further includes at least one positional encoding layer configured to generate second features for the coordinates of the geometry and combine the first features with the second features to generate higher-dimensional features; and
outputting an output tensor comprising encoded coordinates and the higher-dimensional features.

20. The method of claim 19, wherein the deep learning network includes one or more layers configured to downscale the coordinates of the geometry to generate downscaled coordinates, and wherein the output tensor comprises the downscaled coordinates and the higher-dimensional features.

21. The method of claim 20, wherein the at least one position encoding layer of the deep learning network includes a first positional encoding layer that operates on an input of the deep learning network and a second positional encoding layer that operates on the downscaled coordinates.

22. The method of claim 19, wherein the one or more layers of the deep learning network includes three layers configured to progressively downscale the coordinates of the geometry to generate first downscaled coordinates, second downscaled coordinates, and third downscaled coordinates, and wherein the output tensor comprises the third downscaled coordinates that are three-times downscaled and the higher-dimensional features.

23. The method of claim 22, wherein the at least one position encoding layer of the deep learning network includes a first positional encoding layer that operates on an input of the deep learning network, a second positional encoding layer that operates on the first downscaled coordinates, a third positional encoding layer that operates on the second downscaled coordinates, and a fourth positional encoding layer that operates on the third downscaled coordinates.

24. The method of claim 23, wherein at least one of the second positional encoding layer, the third positional encoding layer, or the fourth positional encoding layer is positioned between a layer configured to downscale the coordinates of the geometry and an inception-residual block.

25. The method of claim 19, wherein the at least one positional encoding layer comprises a learned positional encoding layer.

26. The method of claim 25, wherein the learned positional encoding layer is configured as a convolutional layer, a fully connected layer, or a multilayer perceptron.

27. The method of claim 19, wherein the deep learning network includes a plurality of positional encoding layers, and wherein each of the positional encoding layers is configured to use different sets of weights.

28. The method of claim 19, wherein the deep learning network includes a plurality of positional encoding layers, and wherein each of the positional encoding layers is configured to use a same set of weights.

29. The method of claim 19, wherein the at least one positional encoding layer comprises one of a sine and cosine positional encoding layer, a linear positional encoding layer, a radial basis function positional encoding layer, a Fermi-Dirac positional encoding layer, a hybrid positional encoding layer, a relative positional encoding layer, or an image grid positional encoding layer.

30. The method of claim 19, wherein the deep learning network includes a plurality of positional encoding layers, and wherein the plurality of positional encoding layers include at least two types of positional encoding.

31. The method of claim 19, wherein to combine the first features with the second features to generate higher-dimensional features, the positional encoding layer is configured to concatenate the first features with the second features.

32. The method of claim 31, wherein the first features have a feature size of 64 and wherein the higher-dimensional features have a feature size of 192.

33. The method of claim 19, further comprising:
encoding attributes of the frame of point cloud data using the deep learning network, wherein the deep learning network includes one or more layers configured to generate third features for the attributes, and wherein the deep learning network further includes at least one positional encoding layer configured to generate fourth features from the attributes and combine the third features with the fourth features to generate second higher-dimensional features.

34. The method of claim 19, further comprising:
encoding one or more syntax elements, the one or more syntax elements including:
a first syntax element indicating whether positional encoding is enabled,
a second syntax element indicating a type of positional encoding for the at least one positional encoding layer,
a third syntax element indicating a feature size for the at least one positional encoding layer,
a fourth syntax element indicating a location of the at least one positional encoding layer, or
a fifth syntax element indicating an input type for the at least one positional encoding layer.

35. The method of claim 19, further comprising:
performing octree encoding on the coordinates of the output tensor to generate the encoded coordinates;
quantizing the higher-dimensional features to generate quantized higher-dimensional features;
arithmetically encoding the quantized higher-dimensional features of the output tensor using an entropy model to generate encoded higher-dimensional features; and
outputting the encoded coordinates and the encoded higher-dimensional features in an encoded bitstream.

36. The method of claim 19, further comprising:
capturing the frame of point cloud data using a sensor.

37. An apparatus configured to decode encoded point cloud data, the apparatus comprising:
one or more memories configured to store the encoded point cloud data; and
processing circuitry in communication with the one or more memories, the processing circuitry configured to:
receive a frame of the encoded point cloud data, wherein the encoded point cloud data includes an input tensor comprising encoded coordinates and corresponding features;
decode coordinates of a geometry of the frame of the encoded point cloud data using a deep learning network and the input tensor to generate decoded coordinates, wherein the deep learning network includes one or more layers configured to generate first features for the coordinates of the geometry, wherein the deep learning network further includes at least one positional encoding layer configured to generate second features for the coordinates of the geometry and combine the first features with the second features to generate higher-dimensional features, and wherein the deep learning network further includes one or more classifier layers configured to classify the higher-dimensional features to generate the decoded coordinates; and
output the decoded coordinates in a decoded point cloud.

38. The apparatus of claim 37, wherein the coordinates of the input tensor comprise downscaled coordinates, and wherein the deep learning network includes one or more layers configured to upscale the downscaled coordinates to generate upscaled coordinates.

39. The apparatus of claim 38, wherein the at least one position encoding layer of the deep learning network includes a first positional encoding layer that operates on an input of the deep learning network and a second positional encoding layer that operates on the upscaled coordinates.

40. The apparatus of claim 38, wherein the one or more layers of the deep learning network includes three layers configured to progressively upscale the downscaled coordinates to generate first upscaled coordinates, second upscaled coordinates, and third upscaled coordinates.

41. The apparatus of claim 40, wherein the at least one position encoding layer of the deep learning network includes a first positional encoding layer that operates on an input of the deep learning network, a second positional encoding layer that operates on the first upscaled coordinates, a third positional encoding layer that operates on the second upscaled coordinates, and a fourth positional encoding layer that operates on the third upscaled coordinates.

42. The apparatus of claim 41, wherein at least one of the second positional encoding layer, the third positional encoding layer, or the fourth positional encoding layer is positioned between a layer configured to upscaled the downscaled coordinates and an inception-residual block.

43. The apparatus of claim 37, wherein the at least one positional encoding layer comprises a learned positional encoding layer.

44. The apparatus of claim 43, wherein the learned positional encoding layer is configured as a convolutional layer, a fully connected layer, or a multilayer perceptron.

45. The apparatus of claim 37, wherein the deep learning network includes a plurality of positional encoding layers, and wherein each of the positional encoding layers is configured to use different sets of weights.

46. The apparatus of claim 37, wherein the deep learning network includes a plurality of positional encoding layers, and wherein each of the positional encoding layers is configured to use a same set of weights.

47. The apparatus of claim 37, wherein the at least one positional encoding layer comprises one of a sine and cosine positional encoding layer, a linear positional encoding layer, a radial basis function positional encoding layer, a Fermi-Dirac positional encoding layer, a hybrid positional encoding layer, a relative positional encoding layer, or an image grid positional encoding layer.

48. The apparatus of claim 37, wherein the deep learning network includes a plurality of positional encoding layers, and wherein the plurality of positional encoding layers include at least two types of positional encoding.

49. The apparatus of claim 37, wherein to combine the first features with the second features to generate higher-dimensional features, the positional encoding layer is configured to concatenate the first features with the second features.

50. The apparatus of claim 49, wherein the first features have a feature size of 64 and wherein the higher-dimensional features have a feature size of 192.

51. The apparatus of claim 37, wherein the processing circuitry is further configured to:
decode attributes of the frame of the encoded point cloud data using the deep learning network to generate decoded attributes, wherein the deep learning network includes one or more layers configured to generate third features for the attributes, wherein the deep learning network further includes at least one positional encoding layer configured to generate fourth features from the attributes and combine the third features with the fourth features to generate second higher-dimensional features, and wherein the deep learning network further includes one or more layers configured to classify the higher-dimensional features to generate the decoded attributes.

52. The apparatus of claim 37, wherein the processing circuitry is further configured to:
decode one or more syntax elements, the one or more syntax elements including:
a first syntax element indicating whether positional encoding is enabled,
a second syntax element indicating a type of positional encoding for the at least one positional encoding layer,
a third syntax element indicating a feature size for the at least one positional encoding layer,
a fourth syntax element indicating a location of the at least one positional encoding layer, or
a fifth syntax element indicating an input type for the at least one positional encoding layer.

53. The apparatus of claim 37, wherein the processing circuitry is further configured to:
perform octree decoding on the encoded coordinates in an encoded bitstream to recover the encoded coordinates in the input tensor; and
arithmetically decode encoded features in the encoded bitstream to recover the corresponding features in the input tensor.

54. The apparatus of claim 37, further comprising:
a display configured to display the encoded point cloud.

55. A method of decoding a point cloud, the method comprising:
receiving a frame of encoded point cloud data, wherein the encoded point cloud data includes an input tensor comprising encoded coordinates and corresponding features;
decoding coordinates of a geometry of the frame of the encoded point cloud data using a deep learning network and the input tensor to generate decoded coordinates, wherein the deep learning network includes one or more layers configured to generate first features for the coordinates of the geometry, wherein the deep learning network further includes at least one positional encoding layer configured to generate second features for the coordinates of the geometry and combine the first features with the second features to generate higher-dimensional features, and wherein the deep learning network further includes one or more classifier layers configured to classify the higher-dimensional features to generate the decoded coordinates; and
outputting the decoded coordinates in a decoded point cloud.

56. The method of claim 55, wherein the coordinates of the input tensor comprise downscaled coordinates, and wherein the deep learning network includes one or more layers configured to upscale the downscaled coordinates to generate upscaled coordinates.

57. The method of claim 56, wherein the at least one position encoding layer of the deep learning network includes a first positional encoding layer that operates on an input of the deep learning network and a second positional encoding layer that operates on the upscaled coordinates.

58. The method of claim 56, wherein the one or more layers of the deep learning network includes three layers configured to progressively upscale the downscaled coordinates to generate first upscaled coordinates, second upscaled coordinates, and third upscaled coordinates.

59. The method of claim 58, wherein the at least one position encoding layer of the deep learning network includes a first positional encoding layer that operates on an input of the deep learning network, a second positional encoding layer that operates on the first upscaled coordinates, a third positional encoding layer that operates on the second upscaled coordinates, and a fourth positional encoding layer that operates on the third upscaled coordinates.

60. The method of claim 59, wherein at least one of the second positional encoding layer, the third positional encoding layer, or the fourth positional encoding layer is positioned between a layer configured to upscaled the downscaled coordinates and an inception-residual block.

61. The method of claim 55, wherein the at least one positional encoding layer comprises a learned positional encoding layer.

62. The method of claim 61, wherein the learned positional encoding layer is configured as a convolutional layer, a fully connected layer, or a multilayer perceptron.

63. The method of claim 55, wherein the deep learning network includes a plurality of positional encoding layers, and wherein each of the positional encoding layers is configured to use different sets of weights.

64. The method of claim 55, wherein the deep learning network includes a plurality of positional encoding layers, and wherein each of the positional encoding layers is configured to use a same set of weights.

65. The method of claim 55, wherein the at least one positional encoding layer comprises one of a sine and cosine positional encoding layer, a linear positional encoding layer, a radial basis function positional encoding layer, a Fermi-Dirac positional encoding layer, a hybrid positional encoding layer, a relative positional encoding layer, or an image grid positional encoding layer.

66. The method of claim 55, wherein the deep learning network includes a plurality of positional encoding layers, and wherein the plurality of positional encoding layers include at least two types of positional encoding.

67. The method of claim 55, wherein to combine the first features with the second features to generate higher-dimensional features, the positional encoding layer is configured to concatenate the first features with the second features.

68. The method of claim 67, wherein the first features have a feature size of 64 and wherein the higher-dimensional features have a feature size of 192.

69. The method of claim 55, further comprising:
decoding attributes of the frame of the encoded point cloud data using the deep learning network to generate decoded attributes, wherein the deep learning network includes one or more layers configured to generate third features for the attributes, wherein the deep learning network further includes at least one positional encoding layer configured to generate fourth features from the attributes and combine the third features with the fourth features to generate second higher-dimensional features, and wherein the deep learning network further includes one or more layers configured to classify the higher-dimensional features to generate the decoded attributes.

70. The method of claim 55, further comprising:
decoding one or more syntax elements, the one or more syntax elements including:
a first syntax element indicating whether positional encoding is enabled,
a second syntax element indicating a type of positional encoding for the at least one positional encoding layer,
a third syntax element indicating a feature size for the at least one positional encoding layer,
a fourth syntax element indicating a location of the at least one positional encoding layer, or
a fifth syntax element indicating an input type for the at least one positional encoding layer.

71. The method of claim 55, further comprising:
performing octree decoding on the encoded coordinates in an encoded bitstream to recover the encoded coordinates in the input tensor; and
arithmetically decoding encoded features in the encoded bitstream to recover the corresponding features in the input tensor.

72. The method of claim 55, further comprising:
displaying the encoded point cloud.
